(19) United States
(12) Patent Application Publication
(10) Pub. No.: US 2026/0258200 A1
(43) Pub. Date: Sep. 3, 2026

(54) SILOXANE MODIFIED AND SILANE MODIFIED POLYMERS VIA DIRECT INSERTION OF SILYL VINYL GROUPS INTO METAL-CARBON BONDS

(71) Applicant: Dow Global Technologies LLC, Midland, MI (US)

(72) Inventor: Lixin Sun, Sugar Land, TX (US)

(21) Appl. No.: 19/164,024

(22) PCT Filed: Jun. 28, 2024
(86) PCT No.: PCT/US2024/036073

§ 371 Date: Sep. 10, 2025

Related U.S. Application Data
(60) Provisional application No. 63/511,642, filed on Jul. 1, 2023.

(51) Int. Cl. C08G 77/20; C08G 77/442

(52) U.S. Cl. CPC C08G 77/20; C08G 77/442

(57) ABSTRACT

Processes, and related compositions, to form a siloxane modified olefin-based polymer, a silane modified olefin-based polymer, or a silane, each process, as described herein. Each process forms an Si—C bond through insertion of silyl vinyl into a metal carbon bond. The silyl vinyl double bond directly inserts into the metal-carbon bond to form a new, for example, alkyl-Si linkage.

### BACKGROUND OF THE INVENTION

Silicone/polyolefin (Si-POE) blends and grafted copolymers are utilized widely across many application areas, where the silicon character imparts modified surface properties (reduced coefficient of friction, or COF) or moisture cure functionality to the material. Silicones are blended into a variety of ethylene-based polymers to impart improved haptics. Silicone-modified low density polyethylene (LDPE) materials, formed by direct copolymerization of ethylene with silicon monomers, in a high pressure process, are used in wire and cable applications. Silicone functionality is also added to linear low density polyethylene (LLDPE) materials through reactive extrusion methods, using peroxide grafting of silane monomers, such as, for example, vinyltriethoxysilane. Although many examples of these physical blends and reactive extrusion grafting technologies are practiced today, these materials suffer from limitations in ultimate properties related to the blend nature of the materials. A true Si-POE hybrid material is hypothesized to bring several advantages, including enhanced surface modification, improved adhesion, alternative crosslinking mechanisms, as well as potential benefits from imparting controllable crystallinity to silicone products. In particular, there is a need for an efficient and economical process to make Si modified polymers, including random copolymers and block copolymers, with an olefin-based polymer and a silicone source.

International Publication WO 2012/103080 discloses a process for preparing a polyolefin-polysiloxane block copolymer, the process comprising contacting under coupling effective conditions, a polyolefinyl-aluminum compound with an acyclic polysiloxane or cyclic siloxane monomer, in such a way, so as to give a polyolefin-polysiloxane block copolymer. Such a block copolymer comprises a polyolefin block directly covalently bonded to a polysiloxane block, wherein the polyolefin block comprises the polyolefinyl portion of the polyolefinyl-aluminum compound and the polysiloxane block comprises at least a portion of the acyclic polysiloxane. See claim 1. The coupling reaction involves the chain scission of the polysiloxane or cyclic polysiloxane, and is a relatively slow reaction.

U.S. Publication 2022/0073658 discloses telechelic polyolefins of the formula (I), A¹L¹L²A², and processes for preparing the same. This reference discloses a process for preparing a telechelic polyolefin, the process comprising: 1) combining starting materials comprising (A) a monomer component, (B) a chain transfer agent component, and (C) a catalyst component comprising a procatalyst, to form a solution, and polymerizing from greater than 10 mol % to less than, or equal to, 99 mol % of the (A) monomer component in the solution; 2) heating the solution; and 3) recovering a product comprising the telechelic polyolefin. The (B) chain transfer agent component comprises an organoaluminum compound of the formula Al(CH₂CH(Y²)A²)₃, where Y² at each occurrence, independently, is hydrogen or a C₁ to C₃₀ hydrocarbyl group; and A² at each occurrence, independently, is a hydrocarbyl group comprising a hindered double bond. See claim 12. The telechelic polyolefins can be chemically modified, such as by grafting (for example by use of maleic anhydride (MAH), silanes, glycidyl methacrylate, or other grafting agent), halogenation, amination, sulfonation, or other chemical modification. See paragraph [0497].

J. J. Eisch et al., Stereospecific Reductive Alkylation of Acetylenes by Successive Hydralumination and Carbodemetalation, J. Org. Chem., 1976, 41, 2214-2215, discloses the stereospecific cis hydralumination of acetylenes and the alkylation of the aluminate complexes of the resulting vinylalanes. See page 2214. The direct hydralumination of mono- or disubstituted acetylenes is disclosed as providing a convenient and direct route to stereoregular di- and trisubstituted olefins, respectively. Drawbacks lie in the following features: (1) the slow rate with which certain disubstituted acetylenes hydraluminate; (2) the regioisomeric mixtures resulting when R does not equal R′ and (3) the contamination of RHC═CR′Al(i-C₄H₉)₂ with small amounts of R—C═C—A1R₂′ formed from the metalation of terminal alkynes by aluminum alkyls. Trimethylsilyl derivatives of monosubstituted acetylenes can also be hyraluminated. See page 2214.

P. R. Jones et al., Silaethylene Intermediates from alpha-Lithiosilanes. 2. Reactions with Chlorosilanes and 1,3-Butadiene, 1977, J. Am. Chem. Soc., 99(26), 8447-8451,discloses the formation of silaethylene intermediates by the elimination of lithium chloride from alpha-lithiochlorosilanes, under appropriate experimental conditions. The reaction tert-butyllithium with vinyldimethylchlorosilane at low temperatures, in hydrocarbon solvents, is disclosed as resulting in high yields of cis and trans-1,1,3,3-tetramethyl-2,4-dineopenty1-1,3-disilacyclobutanes. When the reaction is carried out in the presence of 1,3-butadiene, apparent [2+2] and [2+4] cycloadducts are produced by the reaction the silaethylene intermediate with butadiene. Among them is 1,1-dimethyl-2-neopenty1-3-vinylsilacyclo-butane, a compound that cannot be formed by the addition of an alpha-lithiochlorosilane to butadiene followed by ring closure. See Abstract.

P. R. Jones et al., alpha-Lithiosilanes. 4. Silaethylene Cycloadditions with Conjugated Dienes, J. Am. Chem. Soc. 1980, 102, 4970-4973, discloses the reaction of vinyldimethylchlorosilane with tert-butyllithium, in the presence of several conjugated dienes. The following dienes: 1,3-butadiene; 2,3-dimethyl-1,3-butadiene; cyclopentadiene; and anthracene; produce cycloadducts of the silaethylene intermediate in hydrocarbon solvents. The presence of tetrahydrofuran in the reaction mixture suppresses the formation of the cycloadducts, in favor of 1,3-disilacyclobutane formation. No cycloadduct is obtained with 2,5-dimethylfuran. This reference discloses that lithium chloride elimination to give silaethylene intermediates occurs in hydrocarbon solvents, while in THF or in the presence of strong Lewis bases, the addition reaction to give alpha-lithiosilanes occurs, and products arising their coupling reactions are obtained. See Abstract.

N. Petzetakis et al., Synthesis of Well Defined Polyethylene-Polydimethylsiloxane-Polyethylene Triblock Copolymers by Diimide-Based Hydrogenation of Polybutadiene Blocks, Macromolecules, 2014, 47, 4151-4159, discloses a route for the synthesis of well-defined polyethylene-b-polydimethylsiloxane-b-polyethylene (EDE) triblock copolymers. Poly(1,4-butadiene)-b-polydimethylsiloxane-b-poly(1,4-butadiene) (BDB) copolymer precursors were synthesized by anionic polymerization, followed by diimide-based hydrogenation. Under the standard hydrogenation conditions, the siloxane bond undergoes scission, resulting in significant degradation of the PDMS block. This reference discloses reaction conditions that avoid PDMS degradation, using optimal hydrogenation conditions. See Abstract.

U.S. Pat. No. 3,691,257 discloses the synthesis of polyolefin siloxane block copolymers using living anionic polymerization (see Abstract). These processes typically employ butadiene or isoprene, which must then be hydrogenated to give a polyolefin equivalent. The monomers for anionic polymerization are very limited, typically styrene or butadiene. Thus, the typical way to make an “polyolefin-like” block copolymer is to make a polybutadiene segment and then remove the unsaturation by hydrogenation. An anionic polymerization is less efficient and more costly for the manufacturing of these block copolymers. Anionic polymerizations, in general, have low efficiencies, and require lower temperatures and longer reaction times.

As discussed above, there remains a need for an efficient and economical process to make Si modified polymers, including random copolymers and block copolymers, with an olefin-based polymer and a silicone source. This need has been met as discussed herein.

### SUMMARY OF THE INVENTION

A process to form a composition comprising a siloxane modified olefin-based polymer, said process comprising reacting A) with B), each as shown below, to form C) as shown below:
A) M[(CR¹R²—CR³R⁴)ₙ-CH₃]ₓ where M is a metal selected from Zn or Al; x is 2 or 3, and if x=2, then M is Zn, and if x=3, then M is Al; each n is independently ≥1; and for each respective n value, each of R¹, R², R³, R⁴ is independently H or a hydrocarbyl; and R¹ may or may not be the same for each successive repeat unit; R² may or may not be the same for each successive repeat unit; R³ may or may not be the same for each successive repeat unit; R⁴ may or may not be the same for each successive repeat unit;
B) a polysiloxane comprising at least one silyl vinyl group;
C) to form one or more polysiloxane-M-polymer complexes, each independently selected from i, ii, iii, iv, v, vi, vii, viii, ix or x:

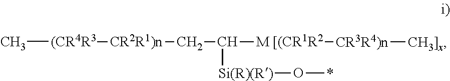

where each n is defined above, and each respective unit of R¹, R², R³, R⁴ is defined above; and each of R and R′ is independently a hydrocarbyl or a heterohydrocarbyl; x=1 or 2, and if x=1, then M is Zn, and if x=2, then M is Al; and the asterisk (*) represents the remainder of the complex;

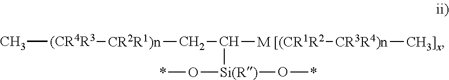

where each n is defined above, and each respective unit of R¹, R², R³, R⁴ is defined above; and R″ is a hydrocarbyl or a heterohydrocarbyl; x=1 or 2, and if x=1, then M is Zn, and if x=2, then M is Al; and each asterisk (*) independently represents the respective remainder of the complex;

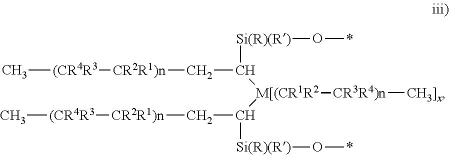

where each n is defined above, and each respective unit of R¹, R², R³, R⁴ is defined above; and each of R and R′ is independently a hydrocarbyl or a heterohydrocarbyl; x=0 or 1, and if x=0 (the [(CR¹R²—CR³R⁴)ₙ-CH₃]) moiety is not present), then M is Zn, and if x=1, then M is Al; and each asterisk (*) independently represents the respective remainder of the complex;

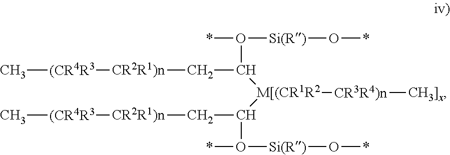

where each n is defined above, and each respective unit of R¹, R², R³, R⁴ is defined above; and each R″ is independently a hydrocarbyl or a heterohydrocarbyl; x=0 or 1, and if x=0 (the [(CR¹R²—CR³R⁴)ₙ-CH₃]) moiety is not present), then M is Zn, and if x=1, then M is Al; and each asterisk (*) independently represents the respective remainder of the complex;

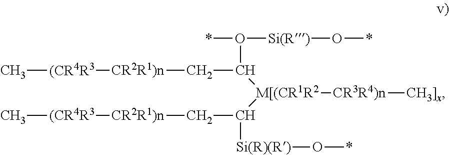

where each n is defined above, and each respective unit of R¹, R², R³, R⁴ is defined above; and each of R, R′ and R″ is independently a hydrocarbyl or a heterohydrocarbyl; x=0 or 1, and if x=0 (the [(CR¹R²—CR³R⁴)ₙ-CH₃]) moiety is not present), then M is Zn, and if x=1, then M is Al; and each asterisk (*) independently represents the respective remainder of the complex;

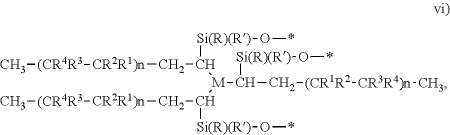

where each n is defined above, and each respective unit of R¹, R², R³, R⁴ is defined above; and each of R and R′ is independently a hydrocarbyl or a heterohydrocarbyl; and M is Al; and each asterisk (*) independently represents the respective remainder of the complex;

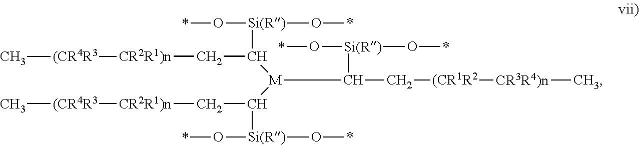

where each n is defined above, and each respective unit of R¹, R², R³, R⁴ is defined above; and each R″ is independently a hydrocarbyl or a heterohydrocarbyl; and M is Al; and each asterisk (*) independently represents the respective remainder of the complex;

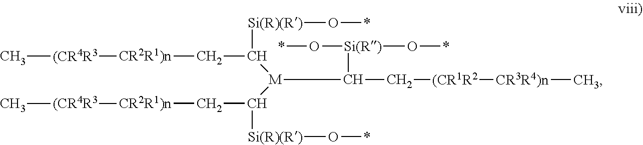

where each n is defined above, and each respective unit of R¹, R², R³, R⁴ is defined above; and each of R, R′ and R″ is independently a hydrocarbyl or a heterohydrocarbyl; and M is Al; and each asterisk (*) independently represents the respective remainder of the complex;

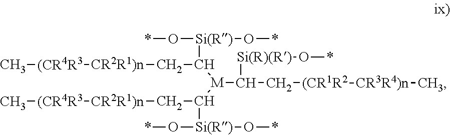

where each n is defined above, and each respective unit of R¹, R², R³, R⁴ is defined above; and each of R, R′ and R″ is independently a hydrocarbyl or a heterohydrocarbyl; and M is Al; and each asterisk (*) independently represents the respective remainder of the complex; or
x) any combination thereof;
hydrolyzing the one or more polysiloxane-M polymer complexes (C) to form the siloxane modified olefin-based polymer.

A process to form a composition comprising a silane modified olefin-based polymer, said process comprising reacting D) with E), each as shown below, to form F) as shown below:
D) M[(CR⁵R⁶—CR⁷R⁸)ₚ-CH₃]ₓ where M is a metal selected from Zn or Al; x is 2 or 3, and if x=2, then M is Zn, and if x=3, then M is Al; each p is independently ≥1; and for each respective p value, each of R⁵, R⁶, R⁷, R⁸ is independently H or a hydrocarbyl; and R⁵ may or may not be the same for each successive repeat unit; R⁶ may or may not be the same for each successive repeat unit; R⁷ may or may not be the same for each successive repeat unit; R⁸ may or may not be the same for each successive repeat unit;
E) a silane comprising at least one silyl vinyl group;
F) to form one or more silane-M-polymer complexes, each independently selected from ic, iic, iiic, or ivc:

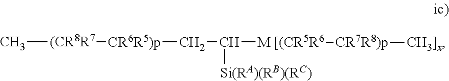

where each p is defined above; and each respective unit of R⁵, R⁶, R⁷, R⁸ is defined above; and each of R^{A}, R^{B} and R^{C} is independently H, a hydrocarbyl or a heterohydrocarbyl; x=1 or 2, and if x=1, then M is Zn, and if x=2, then M is Al;

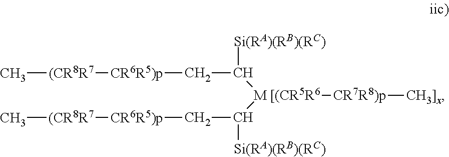

where each p is defined above; and each respective unit of R⁵, R⁶, R⁷, R⁸ is defined above; and each of R^{A}, R^{B} and R^{C} is independently H, a hydrocarbyl or a heterohydrocarbyl; x=0 or 1, and if x=0 (the [(CR⁵R⁶—CR⁷R⁸)ₚ-CH₃]) moiety is not present), then M is Zn, and if x=1, then M is Al;

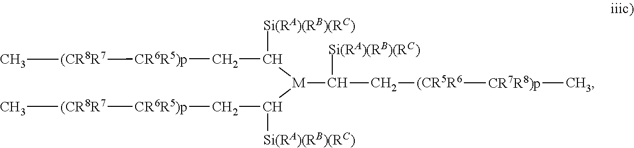

where each p is defined above; and
each respective unit of R⁵, R⁶, R⁷, R⁸ is defined above; and each of R^{A}, R^{B} and R^{C} is independently H, a hydrocarbyl or a heterohydrocarbyl; M is Al; or
ivc) any combination of thereof;
hydrolyzing the one or more silane-M polymer complexes (F) to form the silane modified olefin-based polymer.

A process to form a composition comprising a silane, said process comprising reacting G) with H), each as shown below, to form I) as shown below:
G) M[R⁹]ₓ where M is a metal selected from Zn or Al; x is 2 or 3, and if x=2, then M is Zn, and if x=3, then M is Al; each R⁹ is independently a hydrocarbyl;
H) a silane comprising at least one silyl vinyl group,
I) to form one or more silane-M-molecule complexes, each independently selected from id, iid, iiid, or ivd:

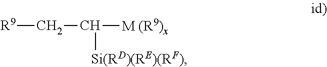

where each R⁹ is defined above; and each of R^{D}, R^{E} and R^{F} is independently H, a hydrocarbyl or a heterohydrocarbyl; x=1 or 2, and when x=1, then M is Zn, and when x=2, then M is Al;

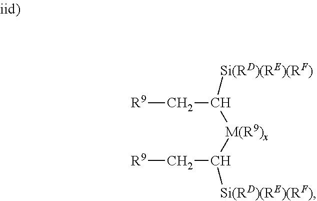

where each R⁹ is defined above; and each of R^{D}, R^{E} and R^{F}is independently H, a hydrocarbyl or a heterohydrocarbyl; x=0 or 1, and when x=0 (the (R⁹) moiety is not present), then M is Zn, and when x=1, then M is Al;

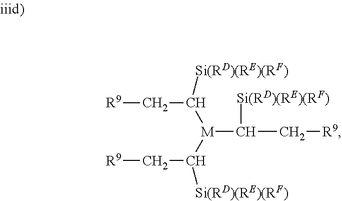

where each R⁹ is defined above; and each of R^{D}, R^{E} and R^{F} is independently H, a hydrocarbyl or a heterohydrocarbyl; M is Al; or
ivd) any combination thereof;
hydrolyzing the one or more silane-M-molecule complexes (I) to form the silane.

A composition comprising a siloxane modified olefin-based polymer, wherein the siloxane modified olefin-based polymer comprises at least one chain comprising at least one structure selected from T1) through T4):

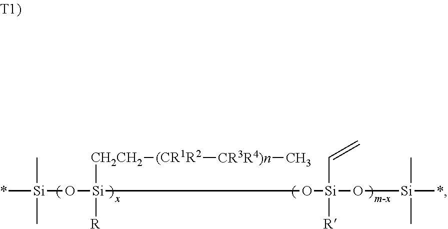

where m≥2; x≥1; n≥1; and for each n value, each of R¹, R², R³, R⁴ is independently H or a hydrocarbyl; and R¹ may or may not be the same for each successive repeat unit; R² may or may not be the same for each successive repeat unit; R³ may or may not be the same for each successive repeat unit; R⁴ may or may not be the same for each successive repeat unit; and each of R and R′ is independently a hydrocarbyl; and each asterisk (*) independently represents the respective remainder of the chain;

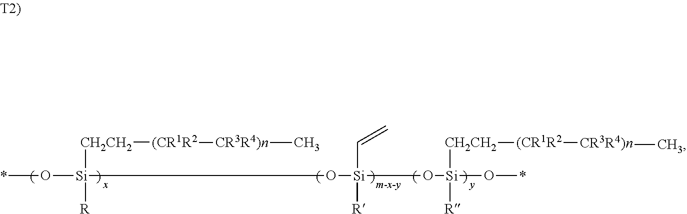

where m≥2; x≥1; y≥1; each n is independently ≥1; and, for each respective n value, each of R¹, R², R³, R⁴ is independently H or a hydrocarbyl; and R¹ may or may not be the same for each successive repeat unit; R² may or may not be the same for each successive repeat unit; R³may or may not be the same for each successive repeat unit; R⁴ may or may not be the same for each successive repeat unit; and each of R, R′ and R″ is independently a hydrocarbyl; and each asterisk (*) independently represents the respective remainder of the chain;

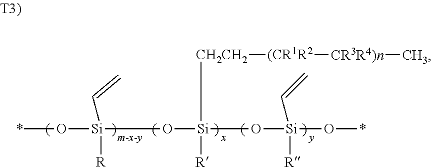

where m≥2; x≥1; y≥1; n≥1; and, for each n value, each of R¹, R², R³, R⁴ is independently H or a hydrocarbyl; and R¹ may or may not be the same for each successive repeat unit; R² may or may not be the same for each successive repeat unit; R³ may or may not be the same for each successive repeat unit; R⁴ may or may not be the same for each successive repeat unit; and each of R, R′ and R″ is independently a hydrocarbyl; and each asterisk (*) independently represents the respective remainder of the chain; or T4) any combination thereof.

### BRIEF DESCRIPTION OF THE DRAWINGS

FIG. 1 is the GC/MS peak spectrum from the hydrolyzed reaction product in Example 1. FIG. 2 is the GC/MS peak spectrum from the hydrolyzed reaction product in Example 2.

FIG. 3 is the overlay of GPC profiles from DMS-V05 (lower), polyethylene (upper) and reaction product containing PE-PDMS block copolymer (middle). See Example 3.

FIG. 4 is the ²⁹Si NMR profile for the reaction product of Example 3. FIG. 5 is the ¹³C NMR profile for the reaction product of Example 3.

FIG. 6 is the overlay of GPC profiles from VMS-T11 (lower), polyethylene (upper) and reaction product containing PE-PDMS block copolymer (middle). See Example 4.

FIG. 7 is the GC/MS peak spectrum from the hydrolyzed reaction product in Example 5.

### DETAILED DRESCRIPTION OF THE INVENTION

A new chemistry is provided regarding a new reaction pathway to form Si-C bond through insertion of silyl vinyl into metal-C bonds, for example, an Al—C bond. This chemistry can be used for olefin-based polymers. In general, the processes provided herein are more efficient and/or more economic than the polymerizations of the art as discussed.

As discussed above, a silyl vinyl double bond directly inserts into a metal-carbon bond to form a new alkyl-silicon linkage, as illustrated in Scheme 1, using aluminum alkyls as the examples. These processes can be used to form polyolefin-polydimethylsiloxane block copolymers as illustrated in Scheme 2.

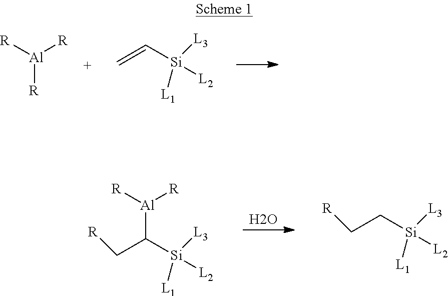

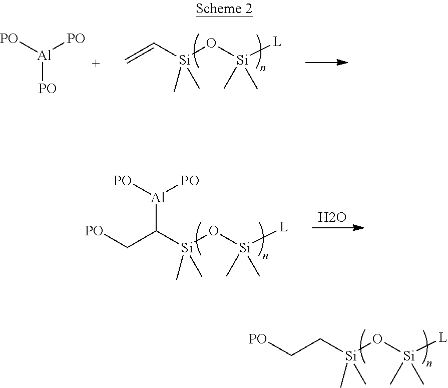

These processes offer an inexpensive pathway to make PO-PDMS block copolymers and PO-g-PDMS copolymers, and more complicated comb structures, as shown in Scheme 3.

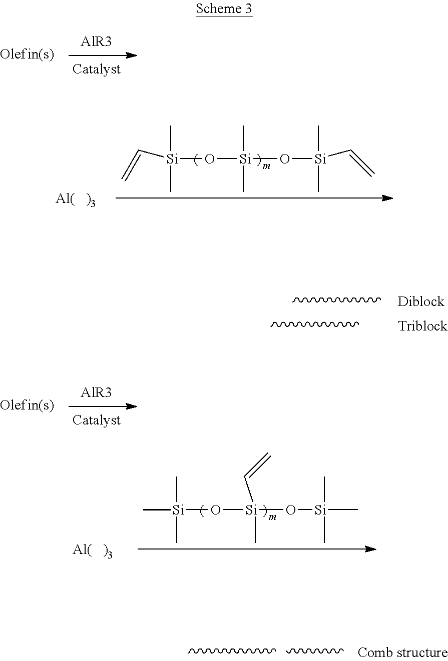

A process to form an Si—C bond is provided, said process comprising inserting a silyl vinyl group into a metal carbon bond, and where the metal is Zn or Al, and further Al. As discussed above, processes are provided to form a composition comprising a siloxane modified olefin-based polymer, a composition comprising a silane modified olefin-based polymer, or a composition comprising a silane. Also provided is a composition comprising a siloxane modified olefin-based polymer, wherein the siloxane modified olefin-based polymer comprises at least one structure selected from T1) through T4), each as described herein. A segments a1 and/or a2, and b, each as described herein (see P] below). In one embodiment, or a combination of two or more embodiments, each described herein, for segment b, each of R′″ and R″″ is independently an H or an alkyl group, and further an alkyl group.

In one embodiment, or a combination of two or more embodiments, each described herein, M is Al.

In one embodiment, or a combination of two or more embodiments, each described herein, the process is a solution process.

In one embodiment, or a combination of two or more embodiments, each described herein, the process further comprises isolating “the composition comprising the siloxane modified olefin-based polymer”. See examples of isolation methods below (item B]).

In one embodiment, or a combination of two or more embodiments, each described herein, the composition further comprises an olefin-based polymer. In one embodiment, or a combination of two or more embodiments, each described herein, the olefin-based polymer is an ethylene-based polymer.

In one embodiment, or a combination of two or more embodiments, each described herein, the siloxane modified olefin-based polymer comprises at least one chain comprising at least one structure selected from T5) through T8), each as described herein (see G3] below).

In one embodiment, or a combination of two or more embodiments, each described herein, the composition comprises ≥15 wt %, or ≥20 wt %, or ≥30 wt %, or ≥40 wt %, or ≥50 wt %, or ≥55 wt %, and/or ≤100 wt %, or ≤95 wt %, or ≤90 wt %, or ≤85 wt %, or ≤80 wt %, or ≤75 wt %, or ≤70 wt %, or ≤65 wt %, or ≤60 wt % of the siloxane modified olefin-based polymer, based on the weight of the composition.

In one embodiment, or a combination of two or more embodiments, each described herein, the composition comprises ≥80.0 wt %, or ≥85.0 wt %, or ≥90.0 wt %, or ≥92.0 wt %, or ≥94.0 wt %, or ≥96.0 wt %, or ≥98.0 wt %, or ≥99.0 wt %, or ≥99.2 wt %, or ≥99.4 wt % and/or ≤100.0 wt %, or ≤99.9 wt %, ≤99.8 wt %, or ≤99.7 wt %, or ≤99.6 wt % of the sum of the siloxane modified polymer and the olefin-based polymer, based on the weight of the composition.

In one embodiment, or a combination of two or more embodiments, each described herein, the siloxane modified olefin-based polymer is a siloxane modified ethylene-based polymer.

Also provided is a crosslinked composition formed from the composition of any one embodiment, or a combination of two or more embodiments, each described herein; or formed from the process of any one embodiment, or a combination of two or more embodiments, each described herein.

Also provided is an article comprising at least one component formed from the composition of any one embodiment, or a combination of two or more embodiments, each described herein; or formed from the process of any one embodiment, or a combination of two or more embodiments, each described herein.

### Additives

A composition may comprise one or more additives. Additives include, but are not limited to, crosslinking agents, cure catalysts, fillers, pigments, UV stabilizers, anti-oxidants, processing aids, solvents, and further crosslinking agents, cure catalysts, UV stabilizers, and anti-oxidants. In one embodiment, an additive is present in an amount ≥0.01 wt %, or ≥0.02 wt %, or ≥0.05 wt %, or ≥0.10 wt %, or ≥0.20 wt %, or ≥0.30 wt %, or ≥0.40 wt %, or ≥0.50 wt % and/or ≤10 wt %, or ≤8.0 wt %, or ≤6.0 wt %, or ≤4.0 wt %, or ≤2.0 wt %, or ≤1.5 wt %, or ≤1.0 wt %, or ≤0.80 wt %, based on the weight of the composition.

### Definitions

Unless stated to the contrary, implicit from the context, or customary in the art, all parts and percents are based on weight, and all test methods are current as of the filing date of this disclosure.

The term “composition,” as used herein, includes a material or a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound (containing polymeric chains or structures) prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers (for example, antioxidants).

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers. The term “olefin-based polymer,” as used herein, refers to a polymer that comprises, in polymerized form, 50 wt % or a majority weight percent of an olefin, such as ethylene or propylene (based on the weight of the polymer), and optionally may comprise one or more comonomers.

The term “ethylene-based polymer,” as used herein, refers to a polymer that comprises, in polymerized form, 50 wt % or a majority weight percent of ethylene (based on the weight of the polymer), and optionally may comprise one or more comonomers.

The term “ethylene/alpha-olefin interpolymer,” as used herein, refers to a interpolymer that comprises, in polymerized form, 50 wt % or a majority weight percent of ethylene (based on the weight of the interpolymer), and an alpha-olefin. The term “ethylene/alpha-olefin copolymer,” as used herein, refers to a copolymer that comprises, in polymerized form, 50 wt % or a majority weight percent of ethylene (based on the weight of the copolymer), and an alpha-olefin, as the only two monomer types.

The term “propylene-based polymer,” as used herein, refers to a polymer that comprises, in polymerized form, a majority weight percent of propylene (based on the weight of the polymer), and optionally may comprise one or more comonomers.

The term “propylene/alpha-olefin interpolymer,” as used herein, refers to interpolymer that comprises, in polymerized form, a majority weight percent of propylene (based on the weight of the interpolymer), and an alpha-olefin. The term “propylene/alpha-olefin copolymer,” as used herein, refers to a copolymer that comprises, in polymerized form, a majority weight percent of propylene (based on the weight of the copolymer), and an alpha-olefin, as the only two monomer types.

The term “propylene/ethylene interpolymer,” as used herein, refers to a interpolymer that comprises, in polymerized form, a majority weight percent of propylene (based on the weight of the interpolymer), and ethylene. The term “propylene/ethylene copolymer,” as used herein, refers to a copolymer that comprises, in polymerized form, a majority weight percent of propylene (based on the weight of the copolymer), and ethylene, as the only two monomer types.

The phrase “a majority weight percent,” as used herein, in reference to a polymer (or interpolymer or copolymer), refers to the amount of monomer present in the greatest amount in the polymer.

The term “crosslinked composition,” as used herein, refers to a composition comprising a crosslinked polymer, which is understood by those skilled in the art, to be a polymer that has a network structure due to the formation of chemical bonds between polymer chains.

The term “heteroatom,” refers to an atom other than hydrogen or carbon (for example, Si, O, N or P, and typically Si or O). The term “heteroatom group” refers to a heteroatom or to a chemical group containing one or more heteroatoms.

The terms “hydrocarbon,” “hydrocarbyl,” and similar terms, as used herein, refer to, respectively, a chemical compound or chemical group, etc., containing only carbon and hydrogen atoms.

The terms “heterohydrocarbon,” “heterohydrocarbyl group,” and similar terms, as used herein, refer to, respectively, a chemical compound or a chemical group, etc., containing carbon, hydrogen, and one or more heteroatom group(s) (for example, Si, O, N or P).

The terms “siloxane or siloxane group,” and similar terms, as used herein, refer to a chemical group or moiety comprising a “—Si—O—Si—” (siloxane) linkage.

The terms “polysiloxane,” and similar terms, as used herein, refer to a molecule comprising one or more “—Si—O—Si—” (siloxane) linkages. Typically the polysiloxane comprises ≥2 siloxane linkages.

The term “polysiloxane comprising at least one silyl vinyl group,” as used herein, refers to a polysiloxane comprising at least one —Si—CH═CH₂ moiety. See, for example, structures s1) through s18) below.

The term “siloxane modified olefin-based polymer,” as used herein, refers to an olefin-based polymer comprising at least one “—Si—O—Si—” (siloxane) linkage.

The term “silane,” as used herein, refers to a “RSi(R^{D})(R^{E})(R^{F})” molecule, where each of R, R^{D}, R^{E}, R^{F} is independently a H, a hydrocarbyl or a heterohydrocarbyl.

The term “silane modified olefin-based polymer,” as used herein, refers to an olefin-based polymer comprising at least one —Si(R^{A})(R^{B})(R^{C}) (silane) linkage, where each of R^{A}, R^{B}, R^{C}, is independently a H, a hydrocarbyl or a heterohydrocarbyl; and wherein the olefin-based polymer does not comprise a “—Si—O—Si—” (siloxane) linkage.

The term “silyl vinyl group,” as used herein, refers to a chemical group or moiety comprising —Si—CH═CH₂.

The term “silane comprising at least one silyl vinyl group,” as used herein, refers to a silane comprising at least one —Si—CH═CH₂ moiety.

The term “polysiloxane-M-polymer complex,” as used herein, refers to a metal complex comprising at least one olefin-based polymer segment and at least one polysiloxane segment. Here, M is Zn or Al.

The term “silane-M-polymer complex,” as used herein, refers to a metal complex comprising at least one olefin-based polymer segment and at least one silane segment. Here, M is Zn or Al.

The term “silane-M-molecule complex,” as used herein, refers to a metal complex comprising at least one hydrocarbyl segment and at least one silane segment. Here, M is Zn or Al.

The term “hydrolyzing,” and similar terms used herein, refer to a chemical reaction in which a polysiloxane-M-polymer complex, a silane-M-polymer complex, or a silane-M-molecule complex reacts with water or an alcohol to break off the “M-(polymer)₂,” the “M-polymer,” the M-(molecule)₂,” the “M-molecule” or the “M” from the respective complex, and to generate a metal complex comprising at least one —OH or at least one —OR moiety, where R is an alkyl group. Here, M is Zn or Al.

The term “catalyst system,” as used herein, refers to catalyst composition comprising a procatalyst and optionally a co-catalyst.

The term “repeat unit,” as used herein, in reference to, for example, the metal complex A, or the complexes i through ix, refers to the (CR⁴R³—CR²R¹) unit, where each of R¹, R², R³, R⁴ is defined herein (for example, see A] below).

The term “repeat unit,” as used herein, in reference to, for example, the metal complex D, or the complexes ic through iiic, refers to the (CR⁵R⁶—CR⁷R⁸) unit, where each of R⁵, R⁶, R⁷, R⁸ is defined herein (for example, see U] below).

The term “repeat unit,” as used herein, in reference to, for example, polymer structures T1, T2 and T3, refers to the (CR⁴R³—CR²R¹) unit, where each of R¹, R², R³, R⁴ is defined herein (for example, see F3] below).

The term “solution process,” as used herein, refers to a chemical reaction process, in which both the starting material(s) and the end product(s) are soluble in the one or more solvents used in this process.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include, for example, any additional additive, adjuvant, or compound, whether polymeric or otherwise, unless stated to the contrary. In contrast, the term “consisting essentially of” excludes from the scope of any succeeding recitation any other component, step or procedure, excepting those that are not essential to operability. The term “consisting of” excludes any component, step or procedure, not specifically delineated or listed.

### Listing of Some Process and Composition Features

A] A process to form a composition comprising a siloxane modified olefin-based polymer, said process comprising reacting A) with B), each as shown below, to form C) as shown below:
A) M[(CR¹R²—CR³R⁴)ₙ-CH₃]ₓ where M is a metal selected from Zn or Al; x is 2 or 3, and if x=2, then M is Zn, and if x=3, then M is Al; each n is independently ≥1; and for each respective n value, each of R¹, R², R³, R⁴ is independently H or a hydrocarbyl; and R¹ may or may not be the same for each successive repeat unit (or R¹ at each occurrence is independently selected from H or a hydrocarbyl); R² may or may not be the same for each successive repeat unit (or R² at each occurrence is independently selected from H or a hydrocarbyl); R³ may or may not be the same for each successive repeat unit (or R³ at each occurrence is independently selected from H or a hydrocarbyl); R⁴ may or may not be the same for each successive repeat unit (or R⁴ at each occurrence is independently selected from H or a hydrocarbyl);
B) a polysiloxane comprising at least one silyl vinyl group;
C) to form one or more polysiloxane-M-polymer complexes, each independently selected from i, ii, iii, iv, v, vi, vii, viii, ix or x:

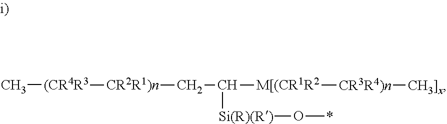

where each n is defined above, and each respective unit of R¹, R², R³, R⁴ is defined above; and each of R and R′ is independently a hydrocarbyl or a heterohydrocarbyl, and further a hydrocarbyl; x=1 or 2, and if x=1, then M is Zn, and if x=2, then M is Al; and the asterisk (*) represents the remainder of the complex;

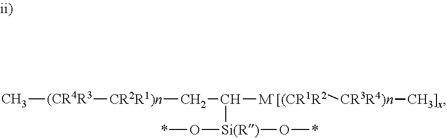

where each n is defined above, and each respective unit of R¹, R², R³, R⁴ is defined above; and R″ is a hydrocarbyl or a heterohydrocarbyl, and further a hydrocarbyl; x=1 or 2, and if x=1, then M is Zn, and if x=2, then M is Al; and each asterisk (*) independently represents the respective remainder of the complex; or listed.

### Listing of Some Process and Composition Features

A] A process to form a composition comprising a siloxane modified olefin-based polymer, said process comprising reacting A) with B), each as shown below, to form C) as shown below:
A) M[(CR¹R²—CR³R⁴)ₙ-CH₃]ₓ where M is a metal selected from Zn or Al; x is 2 or 3, and if x=2, then Mis Zn, and if x=3, then M is Al; each n is independently ≥1; and for each respective n value, each of R¹, R², R³, R⁴ is independently H or a hydrocarbyl; and R¹ may or may not be the same for each successive repeat unit (or R¹ at each occurrence is independently selected from H or a hydrocarbyl); R² may or may not be the same for each successive repeat unit (or R² at each occurrence is independently selected from H or a hydrocarbyl); R³ may or may not be the same for each successive repeat unit (or R³ at each occurrence is independently selected from H or a hydrocarbyl); R⁴ may or may not be the same for each successive repeat unit (or R⁴ at each occurrence is independently selected from H or a hydrocarbyl);
B) a polysiloxane comprising at least one silyl vinyl group;
C) to form one or more polysiloxane-M-polymer complexes, each independently selected from i, ii, iii, iv, v, vi, vii, viii, ix or x:

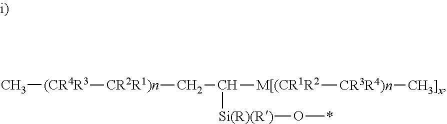

where each n is defined above, and each respective unit of R¹, R², R³, R⁴ is defined above; and each of R and R′ is independently a hydrocarbyl or a heterohydrocarbyl, and further a hydrocarbyl; x=1 or 2, and if x=1, then M is Zn, and if x=2, then M is Al; and the asterisk (*) represents the remainder of the complex;

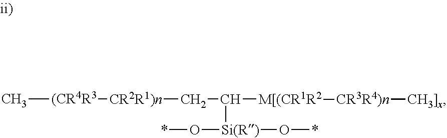

where each n is defined above, and each respective unit of R¹, R², R³, R⁴ is defined above; and R″ is a hydrocarbyl or a heterohydrocarbyl, and further a hydrocarbyl; x=1 or 2, and if x=1, then M is Zn, and if x=2, then M is Al; and each asterisk (*) independently represents the respective remainder of the complex;

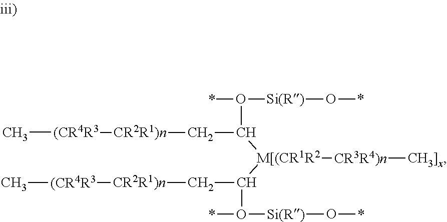

where each n is defined above, and each respective unit of R¹, R², R³, R⁴ is defined above; and each of R and R′ is independently a hydrocarbyl or a heterohydrocarbyl, and further a hydrocarbyl; x=0 or 1, and if x=0 (the [(CR¹R²—CR³R⁴)ₙ-CH₃]) moiety is not present), then M is Zn, and if x=1, then M is Al; and each asterisk (*) independently represents the respective remainder of the complex;

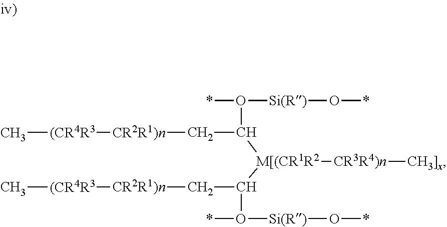

where each n is defined above, and each respective unit of R¹, R², R³, R⁴ is defined above; and each R″ is independently a hydrocarbyl or a heterohydrocarbyl, and further a hydrocarbyl; x=0 or 1, and if x=0 (the [(CR¹R²—CR³R⁴)ₙ-CH₃]) moiety is not present), then M is Zn, and if x=1, then M is Al; and each asterisk (*) independently represents the respective remainder of the complex;

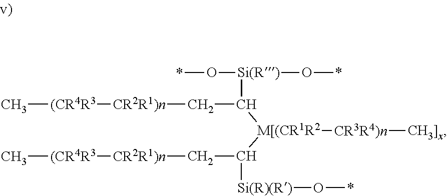

where each n is defined above, and each respective unit of R¹, R², R³, R⁴ is defined above; and each of R, R′ and R″ is independently a hydrocarbyl or a heterohydrocarbyl, and further a hydrocarbyl; x=0 or 1, and if x=0 (the [(CR¹R²—CR³R⁴)ₙ-CH₃]) moiety is not present), then M is Zn, and if x=1, then M is Al; and each asterisk (*) independently represents the respective remainder of the complex;

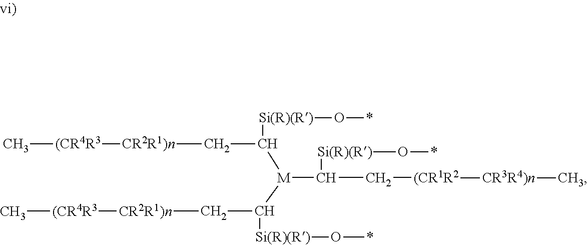

where each n is defined above, and each respective unit of R¹, R², R³, R⁴ is defined above; and each of R and R′ is independently a hydrocarbyl or a heterohydrocarbyl, and further a hydrocarbyl; and M is Al; and each asterisk (*) independently represents the respective remainder of the complex;

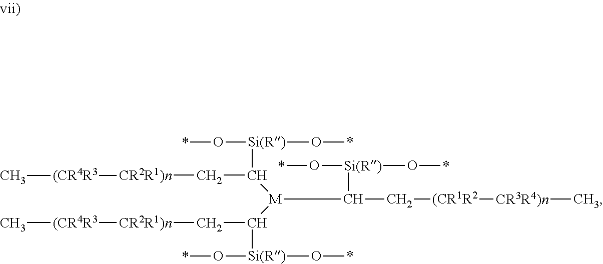

where each n is defined above, and each respective unit of R¹, R², R³, R⁴ is defined above; and each R″ is independently a hydrocarbyl or a heterohydrocarbyl, and further a hydrocarbyl; and M is Al; and each asterisk (*) independently represents the respective remainder of the complex;

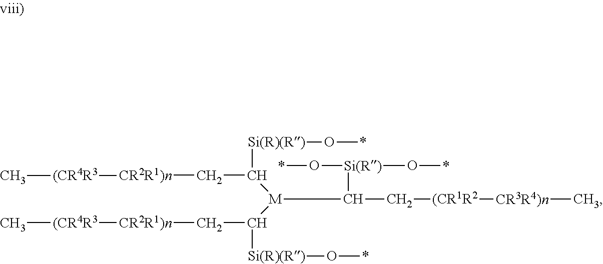

where each n is defined above, and each respective unit of R¹, R², R³, R⁴ is defined above; and each of R, R′ and R″ is independently a hydrocarbyl or a heterohydrocarbyl, and further a hydrocarbyl; and M is Al; and each asterisk (*) independently represents the respective remainder of the complex;

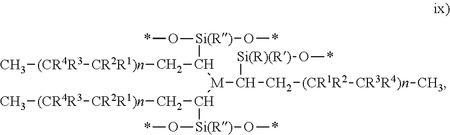

where each n is defined above, and each respective unit of R¹, R², R³, R⁴ is defined above; and each of R, R′ and R″ is independently a hydrocarbyl or a heterohydrocarbyl, and further a hydrocarbyl; and M is Al; and each asterisk (*) independently represents the respective remainder of the complex or
x) any combination thereof; hydrolyzing the one or more polysiloxane-M polymer complexes (C) to form the siloxane modified olefin-based polymer. In a further embodiment, each polysiloxane-M-polymer complex is independently selected from i, ii, iii, iv, v, vi, vii, viii, or ix.

B] The process of A] above, where the process further comprises isolating “the composition comprising the siloxane-modified olefin-based polymer.” Isolation methods are known in the art, and include, but are not limited to, filtration, distillation and extraction. 2-diyl)methane) ]hafnium dimethyl].

P] The process of any one of A]—O] above, wherein the siloxane modified olefin-based polymer comprises the following polymeric segments a1 and/or a2, and b as follows:
a1) —O—Si(R)(R′)—CH₂—CH₂—(CR¹R²—CR³R⁴)ₙ-CH₃, where n is defined herein (for example, see A]); and each of R, R′ is defined herein (for example, see A]); and each of R¹, R², R³, R⁴ is defined herein (for example, see A]);
a2) —O—Si(R″)—CH₂—CH₂—((CR¹R²—CR³R⁴)ₙ-CH₃)—, where n is defined herein (for example, see Al); and R″ is defined herein (for example, see A]); and each of R¹, R², R³, R⁴ is defined herein (for example, see A]);
b) —(O—SiR′″(R″″))ₘ-, where m≥1, and for each value of m, each of R′″and R″″ is independently an H or a hydrocarbyl, and further a hydrocarbyl.

Q] The process of P] above, wherein, for segment b, m≥2, or ≥5, or ≥10, or ≥20, or ≥50, or ≥100 and/or ≤20000, or ≤15000, or ≤10000,or ≤5000,or ≤2000,or ≤1000,or ≤500.

R] The process of P] or Q] above, wherein, for segment b, each of R′″ and R″″ is independently an H or an alkyl group.

S] The process of any one of P]—R] above, wherein, for segment b, each of R′″ and R″″ is independently an alkyl group, or a C1-C5 alkyl group, or a C1-C4 alkyl group, or a C1-C3alkyl group, or a C1-C2 alkyl group, or a methyl group.

T] The process of any one of P]—S] above, wherein, for segment b, R′″═R″″.

U] A process to form a composition comprising a silane modified olefin-based polymer, said process comprising reacting D) with E), each as shown below, to form F) as shown below:
D) M[(CR⁵R⁶—CR⁷R⁸)ₚ-CH₃]ₓ where M is a metal selected from Zn or Al; x is 2 or 3, and if x=2, then M is Zn, and if x=3, then M is Al; each p is independently ≥1; and for each respective p value, each of R⁵, R⁶, R⁷, R⁸ is independently H or a hydrocarbyl; and R⁵ may or may not be the same for each successive repeat unit (or R⁵ at each occurrence is independently selected from H or a hydrocarbyl); R⁶ may or may not be the same for each successive repeat unit (or R⁶ at each occurrence is independently selected from H or a hydrocarbyl); R⁷ may or may not be the same for each successive repeat unit (or R⁷ at each occurrence is independently selected from H or a hydrocarbyl); R⁸ may or may not be the same for each successive repeat unit (or R⁸ at each occurrence is independently selected from H or a hydrocarbyl);
E) a silane comprising at least one silyl vinyl group;
F) to form one or more silane-M-polymer complexes, each independently selected from ic, iic, iiic, or ivc:

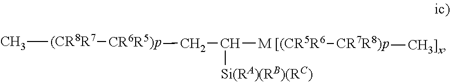

where each p is defined above; and each respective unit of R⁵, R⁶, R⁷, R⁸ is defined above; and each of R^{A}, R^{B} and R^{C} is independently H, a hydrocarbyl or a heterohydrocarbyl, and further H or a hydrocarbyl; x=1 or 2, and if x=1, then M is Zn, and if x=2, then M is Al;

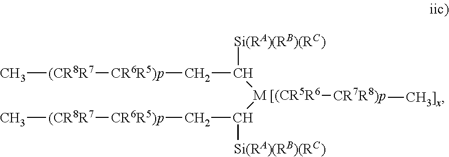

where each p is defined above; and each respective unit of R⁵, R⁶, R⁷, R⁸ is defined above; and each of R^{A}, R^{B} and R^{C} is independently H, a hydrocarbyl or a heterohydrocarbyl, and further H or a hydrocarbyl; x=0 or 1, and if x=0 (the [(CR⁵R⁶—CR⁷R⁸)ₚ-CH₃]) moiety is not present), then M is Zn, and if x=1, then M is Al;

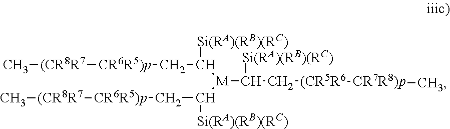

where each p is defined above; and each respective unit of R⁵, R⁶, R⁷, R⁸ is defined above; and each of R^{A}, R^{B} and R^{C} is independently H, a hydrocarbyl or a heterohydrocarbyl, and further H or a hydrocarbyl; M is Al; or
ivc) any combination of thereof;
hydrolyzing the one or more silane-M polymer complexes (F) to form the silane modified olefin-based polymer. In a further embodiment, each silane-M-polymer complex is independently selected from ic, iic or iiic.

V] The process of U] above, where the process further comprises isolating “the composition comprising the silane-modified olefin-based polymer.” See examples of isolation methods discussed above (item B]).

W] The process of U] or V] above, where the process is a solution process.

X] The process of any one of U]—W] above, wherein, independently, for each ic-iiic, each p is independently ≥2, or ≥5, or ≥50, or ≥20, or ≥50, or ≥100, or >500 and/or ≤20000, may not be the same for each successive repeat unit (or R⁵ at each occurrence is independently selected from H or a hydrocarbyl); R⁶ may or may not be the same for each successive repeat unit (or R⁶ at each occurrence is independently selected from H or a hydrocarbyl); R⁷ may or may not be the same for each successive repeat unit (or R⁷ at each occurrence is independently selected from H or a hydrocarbyl); R⁸ may or may not be the same for each successive repeat unit (or R⁸ at each occurrence is independently selected from H or a hydrocarbyl);
E) a silane comprising at least one silyl vinyl group;
F) to form one or more silane-M-polymer complexes, each independently selected from ic, iic, iiic, or ivc:

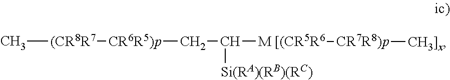

where each p is defined above; and each respective unit of R⁵, R⁶, R⁷, R⁸ is defined above; and each of R^{A}, R^{B} and R^{C} is independently H, a hydrocarbyl or a heterohydrocarbyl, and further H or a hydrocarbyl; x=1 or 2, and if x=1, then M is Zn, and if x=2, then M is Al;

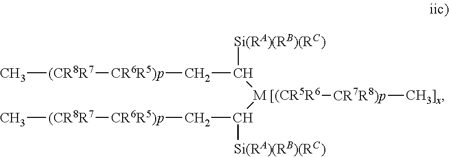

where each p is defined above; and each respective unit of R⁵, R⁶, R⁷, R⁸ is defined above; and each of R^{A}, R^{B} and R^{C} is independently H, a hydrocarbyl or a heterohydrocarbyl, and further H or a hydrocarbyl; x=0 or 1, and if x=0 (the [(CR⁵R⁶—CR⁷R⁸)ₚ-CH₃]) moiety is not present), then M is Zn, and if x=1, then M is Al;

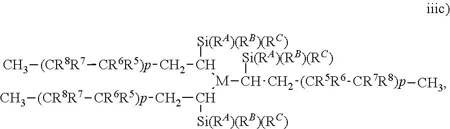

where each p is defined above; and each respective unit of R⁵, R⁶, R⁷, R⁸ is defined above; and each of R^{A}, R^{B}and R^{C} is independently H, a hydrocarbyl or a heterohydrocarbyl, and further H or a hydrocarbyl; M is Al; or
ivc) any combination of thereof;
G) M[R⁹]ₓ where M is a metal selected from Zn or Al; x is 2 or 3, and if x=2, then M is Zn, and if x=3, then M is Al; each R⁹ is independently a hydrocarbyl;
H) a silane comprising at least one silyl vinyl group,
I) to form one or more silane-M-molecule complexes, each independently selected from id, iid, iiid, or ivd:

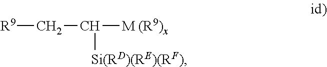

where each R⁹ is defined above; and each of R^{D}, R^{E} and R^{F} is independently H, a hydrocarbyl or a heterohydrocarbyl, and further H or a hydrocarbyl; x=1 or 2, and when x=1, then M is Zn, and when x=2, then M is Al;

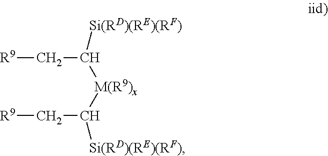

where each R⁹ is defined above; and each of R^{D}, R^{E} and R^{F} is independently H, a hydrocarbyl or a heterohydrocarbyl, and further H or a hydrocarbyl; x=0 or 1, and when x=0 (the (R⁹) moiety is not present), then M is Zn, and when x=1, then M is A1;

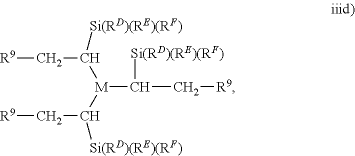

where each R⁹ is defined above; and each of R^{D}, R^{E} and R^{F} is independently H, a hydrocarbyl or a heterohydrocarbyl, and further H or a hydrocarbyl; M is Al; or
ivd) any combination thereof;
hydrolyzing the one or more silane-M-molecule complexes (I) to form the silane. In a further embodiment, each silane-M-molecule complex is independently selected from id, iid or itid.

J2] The process of I2] above, where the process further comprises isolating “the composition comprising the silane.” See examples of isolation methods discussed above. (item B])

K2] The process of [2] or J2] above, where the process is a solution process.

L2] The process of any one of I2]-K2] above, wherein, independently, for each of id-iiid, each of R^{D}, R^{E} and R^{F} is independently an alkyl group or a vinyl group.

M2] The process of any one of I2]-L2] above, wherein, independently, for each of id-iiid, each of R^{D}, R^{E} and R^{F} is independently an alkyl group, or a C1-C5 alkyl group, or a C1-C4 (2,6-di(1-methylethyl)phenyl)amido)(2-isopropylphenyl)(a-naphthalen-2-diyl(6-pyridin-2-diyl)methane)]hafnium dimethyl].

H2] The process of any one of U]-G2] above, wherein the silane modified olefin-based polymer comprises the following polymer c as follows:
c) Si(R^{A})(R^{B})(R^{C})—CH₂—CH₂—(CR⁵R⁶—CR⁷R⁸)ₚ-CH₃, where p is defined above (see, for example, U]); and R^{A}, R^{B} and R^{C} are each defined above (see, for example, U]); and, for each p value, each of R⁵, R⁶, R⁷, R⁸ is defined above (see, for example, U]).

I2] A process to form a composition comprising a silane, said process comprising reacting G) with H), each as shown below, to form I) as shown below:
G) M[R⁹]ₓ where M is a metal selected from Zn or Al; x is 2 or 3, and if x=2, then M is Zn, and if x=3, then M is Al; each R⁹ is independently a hydrocarbyl;
H) a silane comprising at least one silyl vinyl group,
I) to form one or more silane-M-molecule complexes, each independently selected from id, iid, iiid, or ivd:

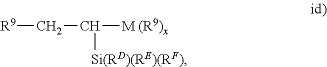

where each R⁹ is defined above; and each of R^{D}, R^{E} and R^{F} is independently H, a hydrocarbyl or a heterohydrocarbyl, and further H or a hydrocarbyl; x=1 or 2, and when x=1, then M is Zn, and when x=2, then M is Al;

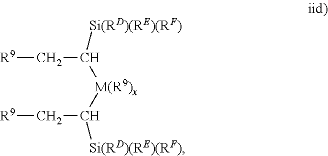

where each R⁹ is defined above; and each of R^{D}, R^{E} and R^{F} is independently H, a hydrocarbyl or a heterohydrocarbyl, and further H or a hydrocarbyl; x=0 or 1, and when x=0 (the (R 9) moiety is not present), then M is Zn, and when x=1, then M is Al;

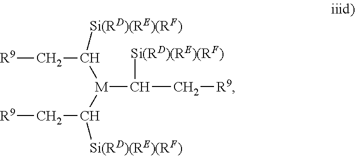

where each R⁹ is defined above; and each of R^{D}, R^{E} and R^{F} is independently H, a hydrocarbyl or a heterohydrocarbyl, and further H or a hydrocarbyl; M is Al; or

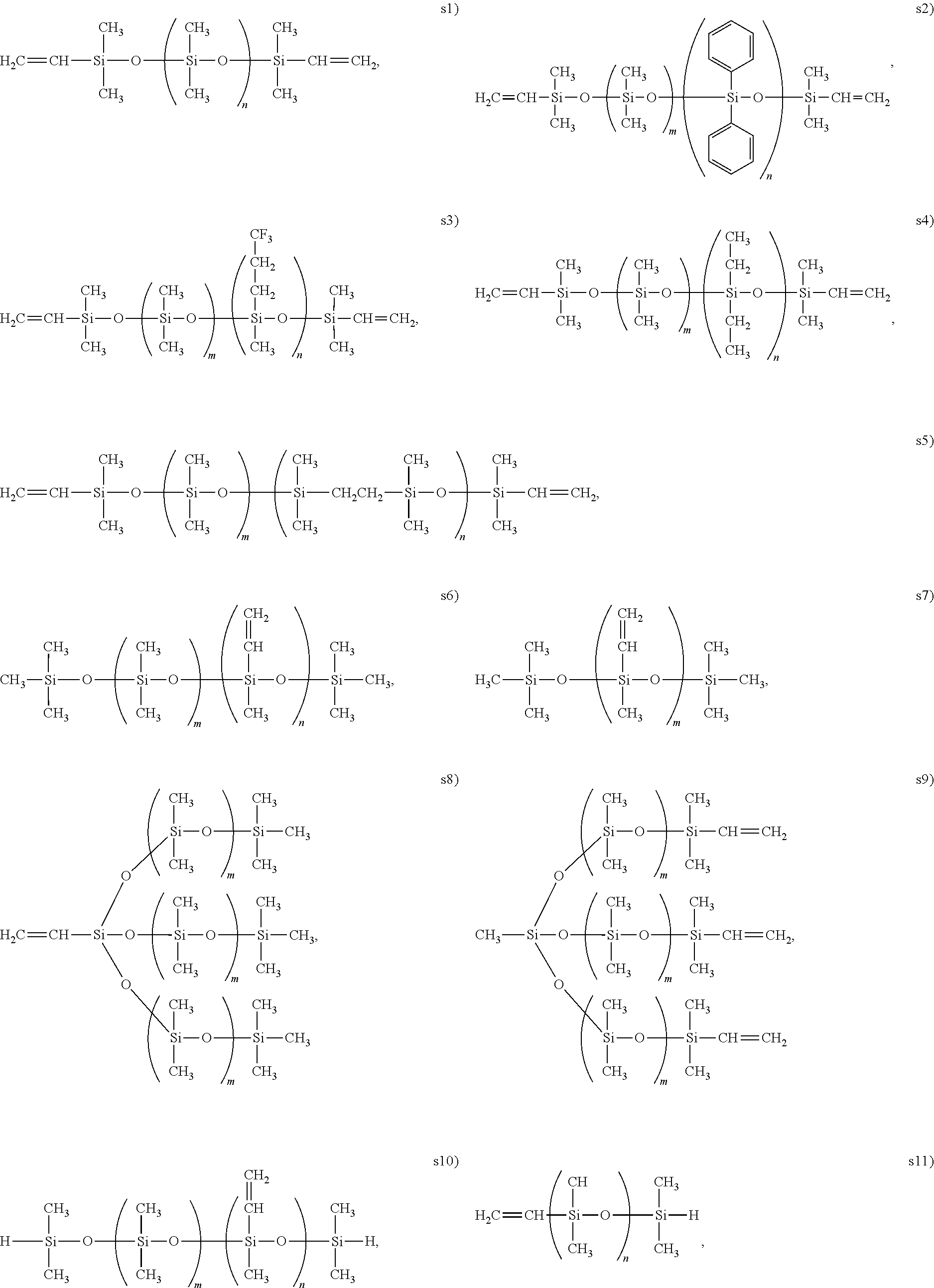

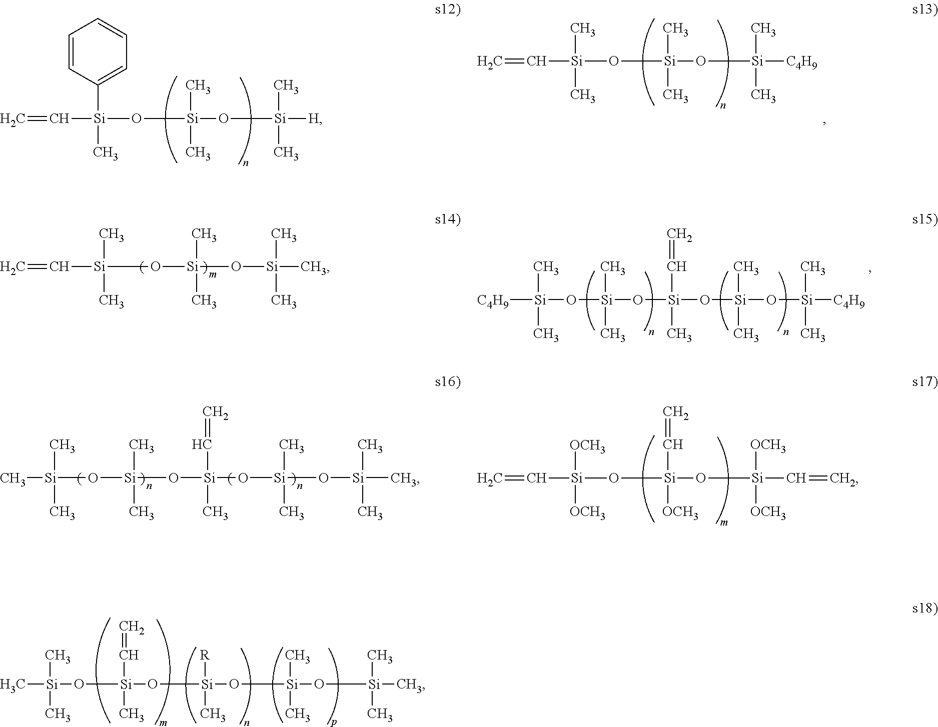

and s19) any combination thereof.

W2] The process of any one of A]-T], U2] or V2] above, wherein the “polysiloxane comprising at least one silyl vinyl group” comprises ≥2, or ≥3, or ≥4, or ≥5, or ≥6, or ≥8, or ≥10 Si atoms per molecule and/or ≤1000, or ≤800, or ≤600, or ≤400,or ≤200,or ≤100, or ≤50 Si atoms per molecule.

X2] The process of any one of A]-T] or U2]-V2] above, wherein “polysiloxane comprising at least one silyl vinyl group” has a density ≥0.80 g/cc, or ≥0.82 g/cc, or ≥0.85
d) Si(RP)(R^{E})(R^{F})—CH₂—CH₂—R⁹, where each of R^{D}, R^{E} and R^{F} is defined above (for example, see I2]), and R⁹ is defined above (for example, see I2]).

U2] The process of any one of A]-T2] above, wherein the process is run at a temperature ≥50 °C, or ≥60 °C, or ≥70 °C, or ≥80 °C, or ≥85 °C, or ≥90C, or ≥95 °C, or ≥100C, or ≥105 °C, or ≥110 °C and/or ≤200 °C, or ≤190C, or ≤180C, or ≤170C, or ≤160C, or ≤150 °C, or ≤145 °C, or ≤140 °C, or ≤135 °C, or ≤130 °C, or ≤125 °C. Further, the process is run under an inert atmosphere (for example, nitrogen).

V2] The process of any one of A]-T] or U2] above, wherein polysiloxane comprising at least one silyl vinyl group is selected from the group consisting of s1) through s19) below; and independently for each of s1)-s6), s10)-s13), s15), s16), s18), each n is independently≥1; and independently for each of s2)-s10), s14), s17), s18), each m is independently≥1; and for s18), p≥1:

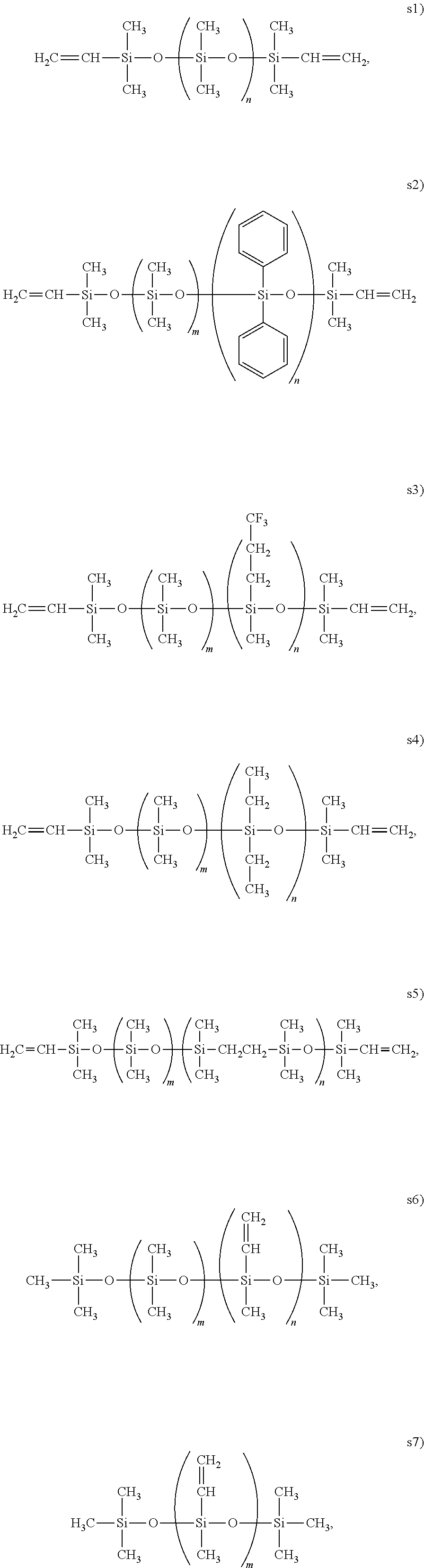

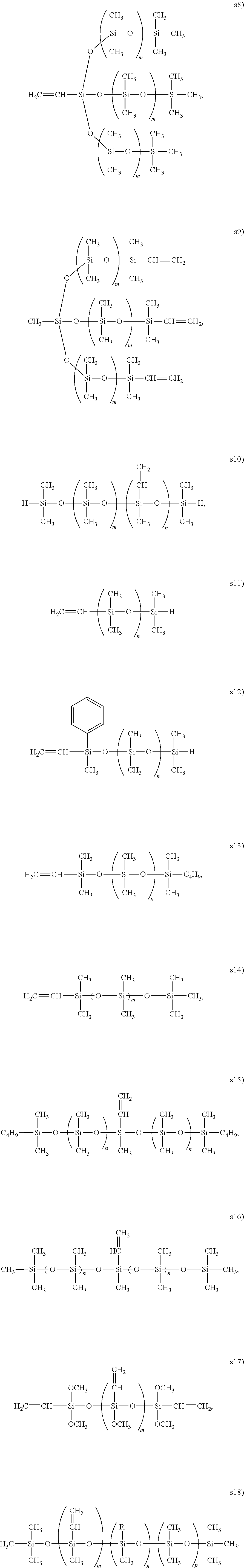

and s19) any combination thereof.

W2] The process of any one of A]-T], U2] or V2] above, wherein the “polysiloxane comprising at least one silyl vinyl group” comprises ≥2, or ≥3, or ≥4, or ≥5, or ≥6, or ≥8, or ≥10 Si atoms per molecule and/or ≤1000, or ≤800, or ≤600,or ≤400,or ≤200,or ≤100, or ≤50 Si atoms per molecule.

X2] The process of any one of A]-T] or U2]-V2] above, wherein “polysiloxane comprising at least one silyl vinyl group” has a density ≥0.80 g/cc, or ≥0.82 g/cc, or ≥0.85 g/cc, or ≥0.87 g/cc, or ≥0.90 g/cc, or ≥0.91 g/cc, or ≥0.92 g/cc, and/or ≤1.0 g/cc, or ≤0.99 g/cc, or ≤0.98 g/cc, or ≤0.97 g/cc (1 cc=1 cm³).

Y2] The process of any one of A]-T] or U2]-W2] above, wherein polysiloxane comprising at least one silyl vinyl group has a wt % of silyl vinyl groups ≥0.50 wt % or ≥0.70 wt %, or ≥1.0 wt %, or ≥1.2 wt %, or ≥1.5 wt %, or ≥1.7 wt %, or ≥2.0 wt % and/or ≤40 wt %, or ≤35 wt %, or ≤30 wt %, or ≤25 wt %, or ≤20 wt %, or ≤15 wt %, based on the weight of the polysiloxane.

A3] A composition formed by the process of any one of A]-Y2] above.

B3] A composition comprising a siloxane modified olefin-based polymer formed by the process of any one of A]-T] or U2]-Y2] above.

C3] The composition of B3], wherein the siloxane modified olefin-based polymer comprising the following polymeric segments a1 and/or a2, and b as follows:
a1) —O—Si(R)(R′)—CH₂—CH₂—(CR¹R²—CR³R⁴)ₙ-CH₃, where n is defined herein (for example, see P]); and each of R, R′ is defined herein (for example, see P]); and each of R¹, R², R³, R⁴ is defined herein (for example, see P]);
a2) —O—Si(R″)—CH₂—CH₂—((CR¹R²—CR³R⁴)ₙ-CH₃)—, where n is defined herein (for example, see P]); and R″ is defined herein (or example, see P]); and each of R¹, R², R³, R⁴ is defined herein (for example, see P]);
b) —(O—SiR′″(R″″))ₘ-, where m s defined herein (or example, see P]); and each of R′″and R″″ is s defined herein (or example, see P]).

D3] A composition comprising a silane modified olefin-based polymer formed by the process of any one of U]-H2] or U2] above.

E3] A composition comprising a silane formed by the process of any one of I2]-T2] or U2] above.

F3] A composition comprising a siloxane modified olefin-based polymer, wherein the siloxane modified olefin-based polymer comprises at least one chain comprising at least one structure selected from T1) through T4):

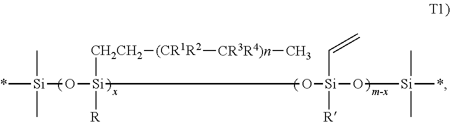

where m≥2; x≥1; n≥1; and each n value, each of R¹, R², R³, R⁴ is independently H or a hydrocarbyl; and R¹ may or may not be the same for each successive repeat unit (or R¹ at each occurrence is independently selected from H or a hydrocarbyl); R² may or may not be the same for each successive repeat unit (or R² at each occurrence is independently selected from H or a hydrocarbyl); R³ may or may not be the same for each successive repeat unit (or R³ at each occurrence is independently selected from H or a hydrocarbyl); R⁴ may or may not be the same for each successive repeat unit (or R⁴ at each occurrence is independently selected from H or a hydrocarbyl); and each of R and R′ is independently a hydrocarbyl; and each asterisk (*) independently represents the respective remainder of the chain;

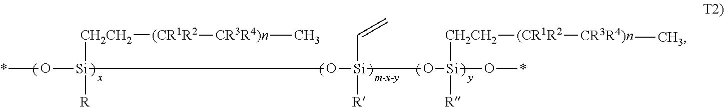

where m≥2 and
Further m≥3; x≥1; y≥1; each n is independently ≥1; and, for each respective n value, each of R¹, R², R³, R⁴ is independently H or a hydrocarbyl; and R¹ may or may not be the same for each successive repeat unit (or R¹ at each occurrence is independently selected from Hor a hydrocarbyl); R² may or may not be the same for each successive repeat unit (or R² at each occurrence is independently selected from H or a hydrocarbyl); R³ may or may not be the same for each successive repeat unit (or R³ at each occurrence is independently selected from H or a hydrocarbyl); R⁴ may or may not be the same for each successive repeat unit (or R⁴ at each occurrence is independently selected from H or a hydrocarbyl); and each of R, R′ and R″ is independently a hydrocarbyl; and each asterisk (*) independently represents the respective remainder of the chain;

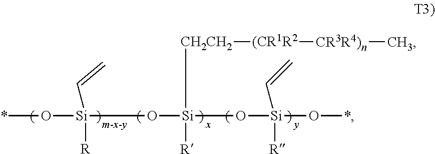

where m≥2 and further m≥3 ; x≥1; y≥1; n≥1; and, for each n value, each of R¹, R², R³, R⁴ is independently H or a hydrocarbyl; and R¹ may or may not be the same for each successive repeat unit (or R¹ at each occurrence is independently selected from H or a hydrocarbyl); R² may or may not be the same for each successive repeat unit (or R² at each occurrence is independently selected from H or a hydrocarbyl); R³ may or may not be the same for each successive repeat unit (or R³ at each occurrence is independently selected from H or a hydrocarbyl); R⁴ may or may not be the same for each successive repeat unit (or R⁴ at each occurrence is independently selected from H or a hydrocarbyl); and each of R, R′ and R″ is independently a hydrocarbyl; and each asterisk (*) independently represents the respective remainder of the chain; or
T4) any combination thereof.

G3] The composition of F3] above, wherein the siloxane modified olefin-based polymer comprises at least one chain comprising at least one structure selected from T5) through T8), and wherein each asterisk (*) independently represents the respective remainder of the chain:

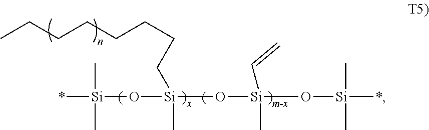

where m≥2; c≥1; n≥1;

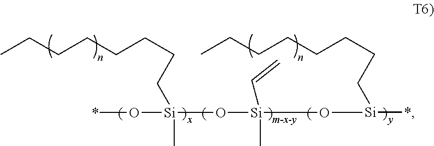

where m≥2 and further m≥3; x≥1; y≥1; each n is independently≥1;

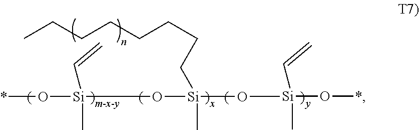

where m≥2 and further m≥3; x≥1; y≥1; n≥1; or
T8) any combination thereof.

H3] The composition of any one of A3]-C3] above, wherein the siloxane modified olefin-based polymer comprises at least one structure selected from T1) through T4), each described above (see F3]).

I3] The composition of H3] above, wherein the siloxane modified olefin-based polymer comprises at least one structure selected from T5) through T8), each described above (see G3]).

J3] The process of any one of A]-H2] or U2]-Y2] above, or the composition of A3]-D3] or F3]-13] above, wherein the composition further comprises a polymer, different from the siloxane modified olefin-based polymer or from the silane modified polymer in one or more features, such as monomer(s) types, Mn, Mw, MWD, density, or any combination thereof.

K3] The process of any one of A]-H2] or U2]-Y2] or J3] above, or the composition of A3]-D3] or F3]-J3] above, wherein the composition further comprises an olefin-based polymer. propylene, 1-butene or 1-octene; or 1-butene or 1-octene; or 1-octene.

I4] The process of any one of A]-T], U2]-Y2] or J3]-D4] above, or the composition of any one of A3]-C3] or F3]-D4] above, wherein the siloxane modified olefin-based polymer is a siloxane modified propylene-based polymer.

J4] The process of I4] above, or the composition of I4] above, wherein the siloxane modified propylene-based polymer is a siloxane modified polypropylene homopolymer.

K4] The process of I4] above, or the composition of I4] above, wherein the siloxane modified propylene-based polymer is a siloxane modified propylene/ethylene interpolymer, and further a siloxane modified propylene/ethylene copolymer; or a siloxane modified propylene/alpha-olefin interpolymer, and further a siloxane modified propylene/alpha-olefin copolymer.

L4] The process of K4] above, or the composition of K4] above, wherein the alpha-olefin is a C4-C20 alpha-olefin; or a C4-C10 alpha-olefin; or selected from 1-butene, 1-pentene, 1-hexene or 1-octene; or 1-butene, 1-hexene or 1-octene; or 1-butene or 1-octene; or 1-octene.

M4] The process of any one of A]-T], U2]-Y2] or J3]-L4] above, or the composition of any one of A3]-C3] or F3]-L4] above, wherein, independently, for each of the polysiloxane-M-polymer complexes, i, through ix, the remainder (*) of the complex or the respective remainder (*) of the complex may or may not independently comprise one or more additional polysiloxane-M-polymer complexes.

N4] The process of M4] above, or the composition of M4] above, wherein the remainder (*) of the complex or the respective remainder (*) of the complex independently comprises one or more additional polysiloxane-M-polymer complexes.

O4] The process of M4] above, or the composition of M4] above, wherein the remainder (*) of the complex or the respective remainder (*) of the complex does not comprise one or more additional polysiloxane-M-polymer complexes.

A5] A crosslinked composition formed from the process of any one of A]-H2], U2]-Y2] or J3]-O4] above.

B5] A crosslinked composition formed from the composition of any one of A3]-D3] or F3-O4] above.

C5] An article comprising the composition of any one of A3]-O4] above.

D5] An article comprising at least one component formed from the composition of any one of A3]-O4] above.

E5] An article comprising the crosslinked composition of A5] or B5] above.

F5] An article comprising at least one component formed from the crosslinked composition of A5] or B5] above.

G5] An article comprising at least one component formed from the process of any one of A]-Y2] or J3]-O4] above.

### TEST METHODS

### Gas Chromatography Mass Spectrometry (GC/MS)

Tandem gas chromatography/low resolution mass spectroscopy using electron impact ionization (EI) was performed at 70 eV, on an Agilent Technologies 6890N series gas chromatograph, equipped with an Agilent Technologies 5975 inert XL mass selective detector and an Agilent Technologies Capillary column (HP1MS, 15 m×0.25 mm, 0.25 micron). The following conditions (programed method) were used: a) Oven Equilibration Time of 0.5 min, b) Oven equilibrated at 50 °C at the start of the analysis, then the temperature was ramp at 25 °C/min to 200 °C, and maintain at 200 °C for 5 minutes, c) Run Time of 11 minutes.

### Density

The density of a polymer is measured by preparing the polymer sample according to ASTM D 1928, and then measuring the density according to ASTM D792, Method B, within one hour of sample pressing.

### Gel Permeation Chromatography

### Compositional Conventional GPC

The chromatographic system consisted of a PolymerChar GPC-IR (Valencia, Spain) high temperature GPC chromatograph equipped with an internal IR5 infra-red detector (IR5). The autosampler oven compartment was set at 160° Celsius and the column compartment was set at 150° Celsius. The columns used were 4 Agilent “Mixed A” 30 cm, 20-micron linear mixed-bed columns. The chromatographic solvent was 1,2,4 trichlorobenzene, which contained 200 ppm of butylated hydroxytoluene (BHT). The solvent source was nitrogen sparged. The injection volume was 200 microliters and the flow rate was 1.0 milliliters/minute.

Calibration of the GPC column set was performed with 21 narrow molecular weight distribution polystyrene standards with molecular weights ranging from 580 to 8,400,000 g/mol and which were arranged in 6 “cocktail” mixtures with at least a decade of separation between individual molecular weights. The standards were purchased from Agilent Technologies. The polystyrene standards were prepared at “0.025 grams in 50 milliliters of solvent” for molecular weights equal to or greater than 1,000,000, and “0.05 grams in 50 milliliters of solvent” for molecular weights less than 1,000,000. The polystyrene standards were pre-dissolved at 80 °C with gentle agitation for 30 minutes, then cooled, and the “room temperature solution” was transferred cooled into the autosampler dissolution oven at 160 °C for 30 minutes. The polystyrene standard peak molecular weights were converted to polyethylene molecular weights using Equation 1 (as described in Williams and Ward, J. Polym. Sci., Polym. Let., 6, 621(1968 )): M_{polyethylene}=A×(M_{polystyrene})^{B} (EQ1), where M is the molecular weight, A has a value of 0.424 and B is equal to 1.0. A fifth order polynomial was used to fit the respective polyethylene-equivalent calibration points.

The total plate count of the GPC column set was performed with decane, which was introduced into a blank sample via a micropump controlled with the PolymerChar GPC-IR system. The plate count for the chromatographic system should be greater than 18,000 for the 4 Agilent “Mixed A” 30 cm, 20-micron linear mixed-bed columns. Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. After calibrating the system based on a flow marker peak, the effective flowrate (with respect to the narrow standards calibration) is calculated as Equation 2. Processing of the flow marker peak was done via the PolymerChar GPCOne™ Software. Acceptable flowrate correction is such that the effective flowrate should be within +/−0.5% of the nominal flowrate. Flowrate(effective)=Flowrate(nominal)*(RV(FM Calibrated)/RV(FM Sample)) (EQ2)

### IR5 GPC Octene Composition Calibration

A calibration for the IR5 detector rationing was performed using at least ten ethylene-based polymer standards (octene as comonomer), made by a single-site metallocene catalyst from a single reactor in a solution process (polyethylene homopolymer and ethylene/octene copolymers), of a narrow short-chain branching (SCB or CH₃) distribution and known comonomer content (as measured by ¹³C NMR Method, Qiu et al., Anal. Chem. 2009, 81, 8585-8589). These standards ranged from homopolymer (0 SCB/1000 total C) to approximately 40 SCB/1000 total C, where total C=carbons in backbone+carbons in branches. Each standard had a weight-average molecular weight from 36,000 g/mole to 126,000 g/mole measured by GPC. Each standard had a molecular weight distribution (Mw/Mn) from 2.0 to 2.5. Polymer properties for the SCB standards are shown in Table A.

TABLE A
“SCB” Standards

| Wt % Comonomer | SCB/1000 Total C | Mw | Mw/Mn |
|---|---|---|---|
| 23.1 | 28.9 | 37,300 | 2.22 |
| 14.0 | 17.5 | 36,000 | 2.19 |
| 0.0 | 0.0 | 38,400 | 2.20 |
| 35.9 | 44.9 | 42,200 | 2.18 |
| 5.4 | 6.8 | 37,400 | 2.16 |
| 8.6 | 10.8 | 36,800 | 2.20 |
| 39.2 | 49.0 | 125,600 | 2.22 |
| 1.1 | 1.4 | 107,000 | 2.09 |
| 14.3 | 17.9 | 103,600 | 2.20 |
| 9.4 | 11.8 | 103,200 | 2.26 |

The “IR5 Area Ratio (or “IR5_{Methyl Channel Area}/IR5_{Measurement Channel Area}”)” of “the baseline-subtracted area response of the IR5 methyl channel sensor” to “the baseline-subtracted area response of the IR5 measurement channel sensor” (standard filters and filter wheel as supplied by PolymerChar: Part Number IR5_FWM01SS included as part of the GPC-IR instrument) was calculated for each of the “SCB” standards. A linear fit of the SCB frequency versus the “IR5 Area Ratio” was constructed in the form of the following Equation 3: SCB/1000 total C=A₀+[A₁×(IR5_{Methyl Channel Area}/IR5_{Measurement Channel Area})] (EQ 3), where A₀ is the “SCB/1000 total C” intercept at an “IR5 Area Ratio” of zero, and A₁ is the slope of the “SCB/1000 total C” versus “IR5 Area Ratio” and represents the increase in the SCB/1000 total C as a function of “IR5 Area Ratio.” The IR5 area ratio is equal to the IR5 height ratio for narrow PDI and narrow SCBD standard materials.

The overlay of the GPC profiles can be done using commercially available software, such as, for example, software available with the chromatographic system, or Excel software; or by other means known in the art.

### NMR (13C and 29Si)

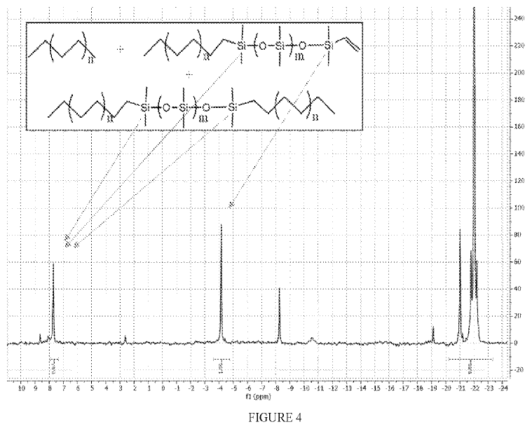

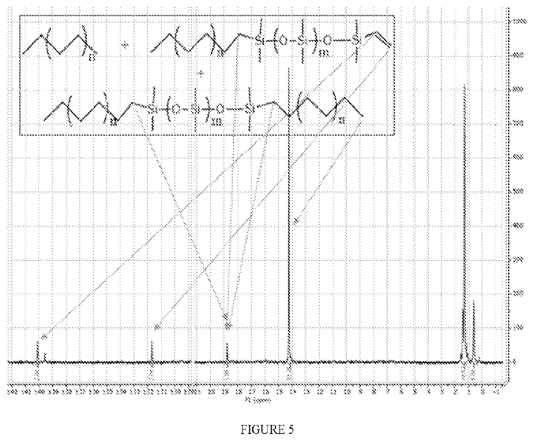

Both ¹³C NMR and ²⁹Si NMR spectra were each collected using a Bruker 600 MHZ Avance III HD system, equipped with a “10 mm multinuclear, helium NMR cryoprobe.” A conventional zgig pulse sequence was used. The polymer samples were prepared by adding approximately “2.6 g of a 50/50 mixture of tetrachloroethane-d₂/orthodichlorobenzene containing 0.025 M chromium trisacetylacetonate (relaxation agent)” to “0.2 g of polymer” in a 10 mm NMR tube. The samples were dissolved and homogenized by heating the tube and its contents to 150 °C. The data was acquired using 320 scans per data file, with a 7.3 second pulse repetition delay with a sample temperature of 120 °C. More NMR samples and parameters are detailed in Z. Zhou et al., Macromolecules 2023, 56, 234-240, incorporated herein by reference. The respected peak integrations are shown in FIGS. 4 and 5.

### EXPERIMENTAL

Reagents, co-catalyst and procatalysts are shown below.

Vinyl Terminated Polydimethylsiloxane (DMS-V05), MW of 800, viscosity of 4-8, density of 0.93, wt % vinyl of 7-9, vinyl (eq/kg) of 2.4-2.9, available from Gelest.

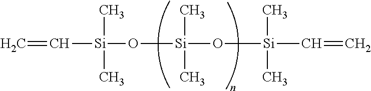

1,3-Divinyltetramethyldisiloxane (DVTMDS), MW of 186.40 g/mol, available from Sigma-Aldrich.

Octenyldimethylvinylsilane (ODMVS) available from Gelest.

Vinylmethylsiloxane Homopolymer (VMS-T11), linear, MW of 1000-5000, viscosity of 7-15, density of 0.96, available from Gelest.

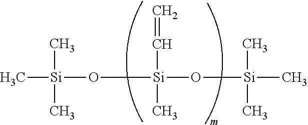

Triethylaluminum (TEA) available from Sigma-Aldrich.

Trioctylaluminum (TOA) available from Sigma-Aldrich.

Diethylzinc (DEZ) available from Sigma-Aldrich.

ISOPAR-E solvent available from ExxonMobil.

Decane solvent available from Sigma-Aldrich.

Co-Catalyst 1 (Co-Cat 1) is bis(hydrogenated tallow alkyl)methyl, tetrakis(penta-fluoro-phenyl)borate(1-) amine, available from Boulder Scientific.

Procatalyst (1): (E)-((2,6-Diisopropylphenyl)(2-methyl-3-(octylimino)butan-2-yl)amino)trimethyl hafnium:

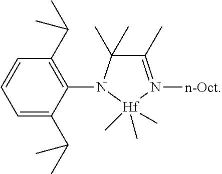

Procatalyst (2): (N-((6E)-6-(Butylimino-κN)-1-cyclohexen-1-yl)-2,6-bis(1-methyl-ethyl)benzenaminato-κN)trimethyl-hafnium:

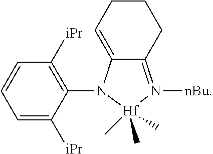

Procatalyst (3): [N-(2,6-Di(1-methylethyl)phenyl)amido)(2-isopropylphenyl)(α-naphthalen-2-diyl(6-pyridin-2-diyl)methane)]hafnium dimethyl]:

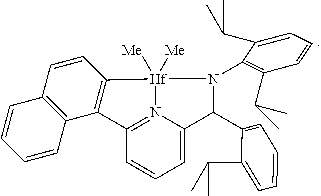

### Study 1-GC Mass Spec of Reaction Products (Al)

### Example 1

The reaction of trioctylaluminum (TOA) with 1,3-divinyltetramethyldisiloxane (DVTMDS) followed Scheme 4 as shown below.

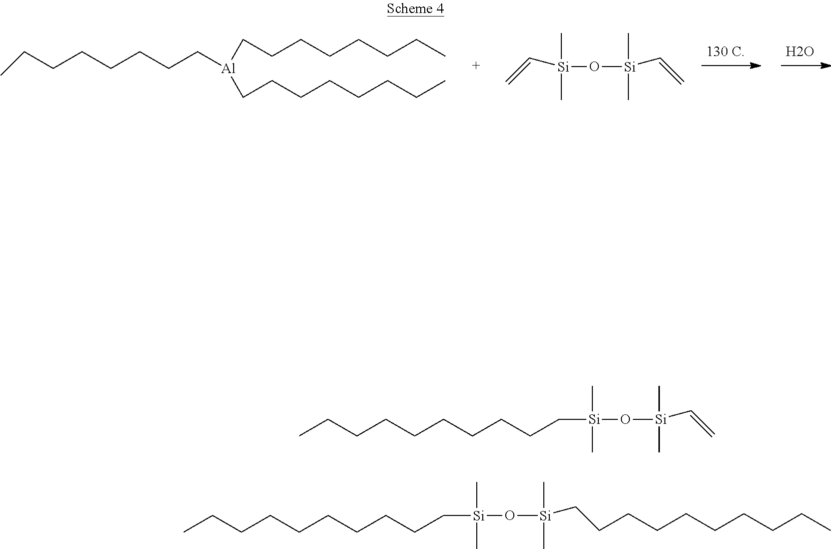

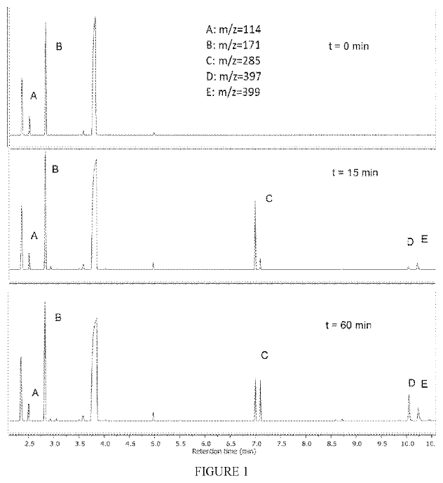

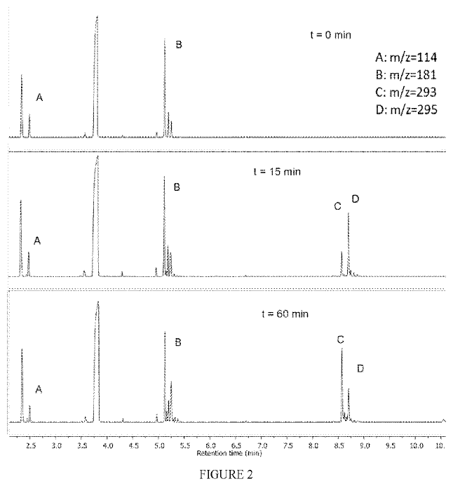

In a drybox, under nitrogen atmosphere, 1,3-divinyltetramethyldisiloxane (0.254 g, 1.364 mmol) and trioctylaluminum (0.1 g, 0.273 mmol) were dissolved in 5 mL of decane, in a vial, and heated to 130 °C (temperature of a heating block). Samples, taken at 15 minutes and one hour, were each hydrolyzed (with MeOH) for GC/MS analysis, to monitor the formation of the inserted products. GC/MS results are shown in FIG. 1. The GC/MS results indicated the presence of the following molecular species (A through E) below. These results confirmed the reaction of Scheme 4 above.

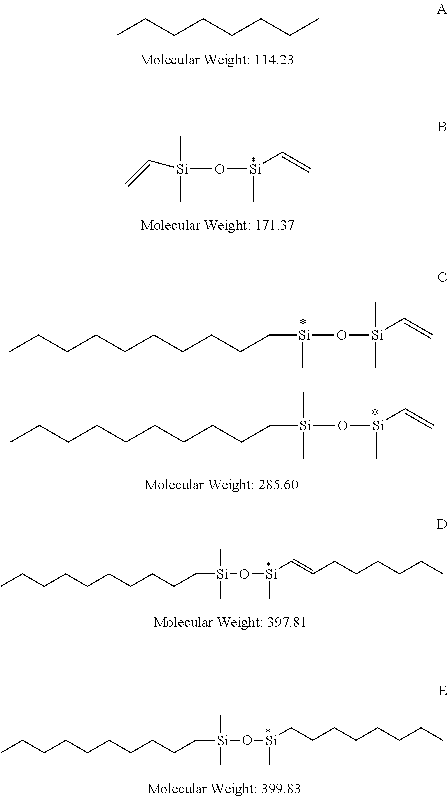

SCB/1000 total C as a function of “IR5 Area Ratio.” The IR5 area ratio is equal to the IR5 height ratio for narrow PDI and narrow SCBD standard materials.

The overlay of the GPC profiles can be done using commercially available software, such as, for example, software available with the chromatographic system, or Excel software; or by other means known in the art.

### NMR (13C and 29Si)

Both ¹³C NMR and ²⁹Si NMR spectra were each collected using a Bruker 600 MHz Avance III HD system, equipped with a “10 mm multinuclear, helium NMR cryoprobe.” A conventional zgig pulse sequence was used. The polymer samples were prepared by adding approximately “2.6 g of a 50/50 mixture of tetrachloroethane-d₂/orthodichlorobenzene containing 0.025 M chromium trisacetylacetonate (relaxation agent)” to “0.2 g of polymer” in a 10 mm NMR tube. The samples were dissolved and homogenized by heating the tube and its contents to 150 °C. The data was acquired using 320 scans per data file, with a 7.3 second pulse repetition delay with a sample temperature of 120 °C. More NMR samples and parameters are detailed in Z. Zhou et al., Macromolecules 2023, 56, 234-240, incorporated herein by reference. The respected peak integrations are shown in FIGS. 4 and 5.

### EXPERIMENTAL

Reagents, co-catalyst and procatalysts are shown below.

Vinyl Terminated Polydimethylsiloxane (DMS-V05), MW of 800, viscosity of 4-8, density of 0.93, wt % vinyl of 7-9, vinyl (eq/kg) of 2.4-2.9, available from Gelest.

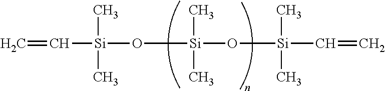

1,3-Divinyltetramethyldisiloxane (DVTMDS), MW of 186.40 g/mol, available from Sigma-Aldrich.

Octenyldimethylvinylsilane (ODMVS) available from Gelest.

Vinylmethylsiloxane Homopolymer (VMS-T11), linear, MW of 1000-5000, viscosity of 7-15, density of 0.96, available from Gelest.

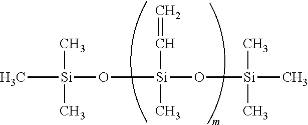

Triethylaluminum (TEA) available from Sigma-Aldrich.

Trioctylaluminum (TOA) available from Sigma-Aldrich.

Diethylzinc (DEZ) available from Sigma-Aldrich.

ISOPAR-E solvent available from ExxonMobil.

Decane solvent available from Sigma-Aldrich.

Co-Catalyst 1 (Co-Cat 1) is bis(hydrogenated tallow alkyl)methyl, tetrakis(penta-fluoro-phenyl)borate(1-) amine, available from Boulder Scientific.

Procatalyst (1): (E)-((2,6-Diisopropylphenyl)(2-methyl-3-(octylimino)butan-2-yl)amino)trimethyl hafnium:

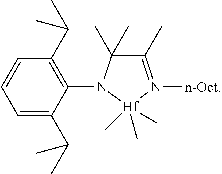

Procatalyst (2): (N-((6E)-6-(Butylimino-κN)-1-cyclohexen-1-yl)-2,6-bis(1-methyl-ethyl)benzenaminato-κN)trimethyl-hafnium:

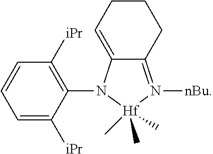

Procatalyst (3): [N-(2,6-Di(1-methylethyl)phenyl)amido)(2-isopropylphenyl)(α-naphthalen-2-diyl(6-pyridin-2-diyl)methane)]hafnium dimethyl]:

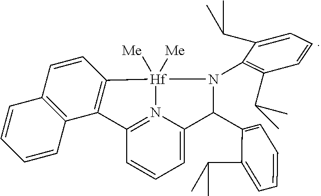

### Study 1—GC Mass Spec of Reaction Products (Al)

### Example 1

The reaction of trioctylaluminum (TOA) with 1,3-divinyltetramethyldisiloxane (DVTMDS) followed Scheme 4 as shown below.

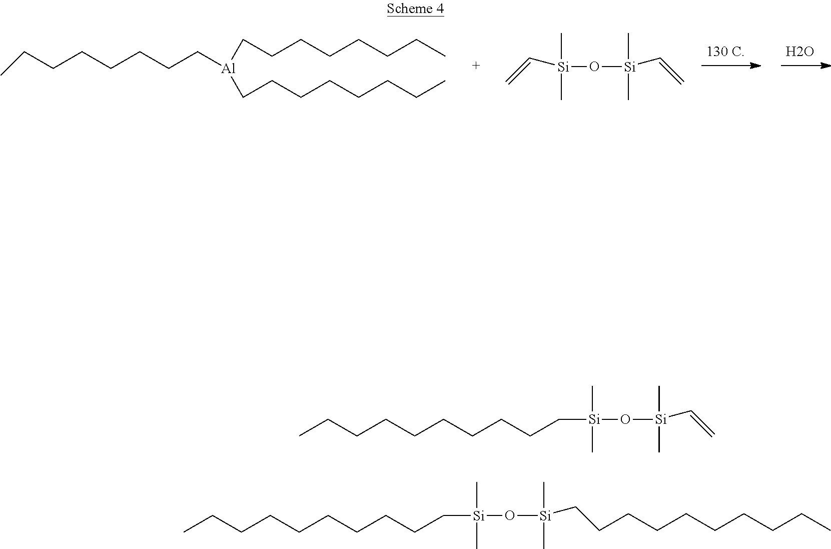

In a drybox, under nitrogen atmosphere, 1,3-divinyltetramethyldisiloxane (0.254 g, 1.364 mmol) and trioctylaluminum (0.1 g, 0.273 mmol) were dissolved in 5 mL of decane, in a vial, and heated to 130 °C (temperature of a heating block). Samples, taken at 15 minutes and one hour, were each hydrolyzed (with MeOH) for GC/MS analysis, to monitor the formation of the inserted products. GC/MS results are shown in FIG. 1. The GC/MS results indicated the presence of the following molecular species (A through E) below. These results confirmed the reaction of Scheme 4 above.

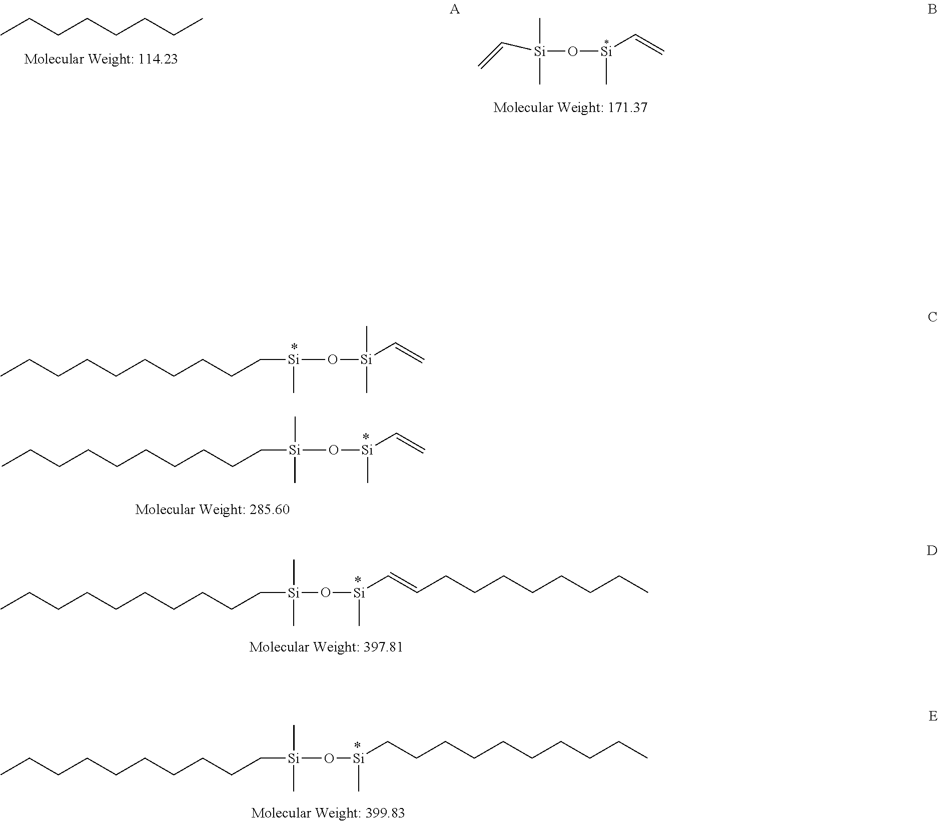

The GC peak with m/z of 114 is octane formed from hydrolysis of TOA. The peak with m/z of 171 is the fragment of the starting siloxane after losing a methyl radical. The sample taken at 15 min showed three new product peaks C, D and E with m/z of 285, 397 and 399, respectively (FIG. 1), which are consistent to the fragments of products with octane added to one vinyl group or both vinyl groups. The sample taken at one hour (see FIG. 1) showed growth of the product peaks.

### Example 2

The reaction of trioctylaluminum (TOA) with octenyldimethylvinylsilane (ODMVS) is shown in Scheme 5 below.

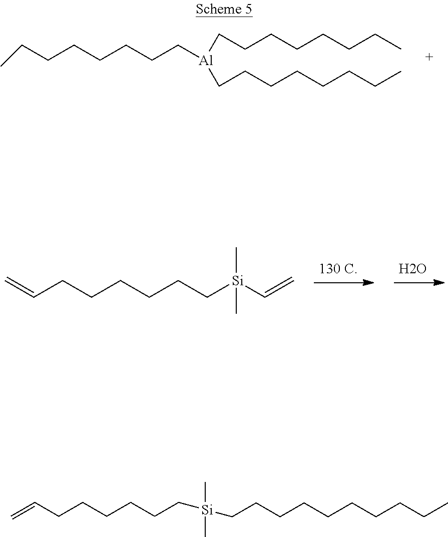

In the drybox, under nitrogen atmosphere, octenyldimethylvinylsilane (ODMVS) (0.536 g, 2.73 mmol) and trioctylaluminum (0.1 g, 0.273 mmol) were dissolved in 5 mL of decane, in a vial, and heated to 130 °C. Samples, taken at 15 minutes and one hour, were each hydrolyzed (with MeOH) for GC/MS analysis, to monitor the formation of inserted products. Results are shown in FIG. 2. The GC/MS results indicated the presence of the following molecular species (A through D) below. These results confirmed the reaction of Scheme 5 above.

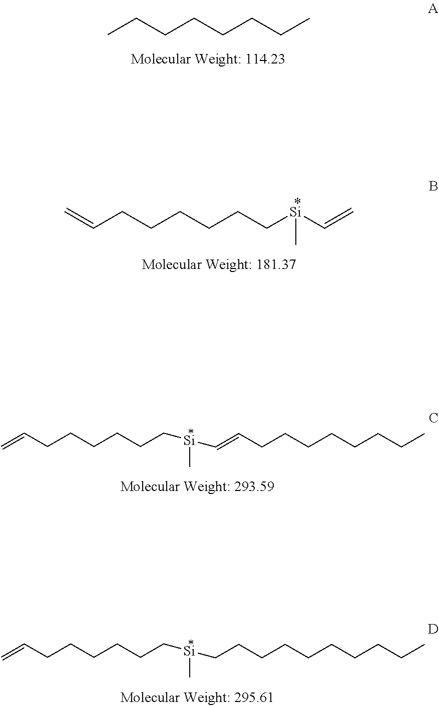

The peak A with m/z of 114 is octane formed from hydrolysis of TOA. The peak B with m/z of 181 is the fragment of starting silane after losing a methyl radical. The new peaks C and D with m/z of 293 and 295, respectively, are consistent to the fragments of products with octane added to silyl vinyl group as shown above.

### Study 2—Polymer Syntheses—Solution Processes

Example 3

The preparation of a polyethylene-PDMS linear block polymer is shown below in Scheme 6.

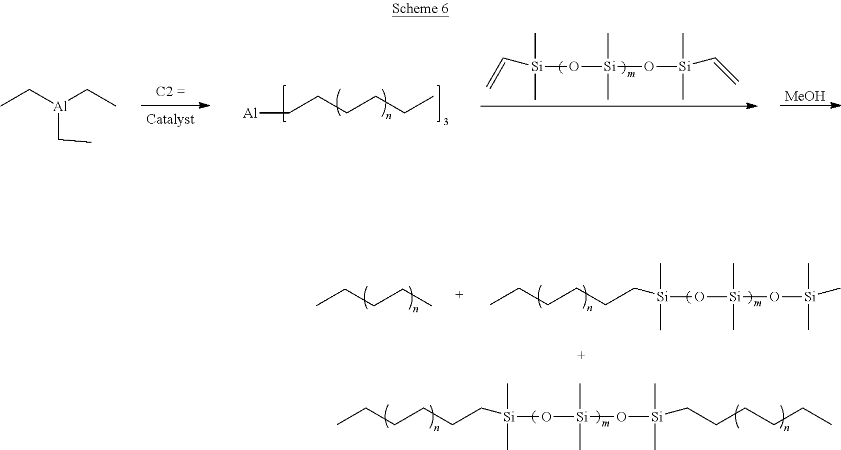

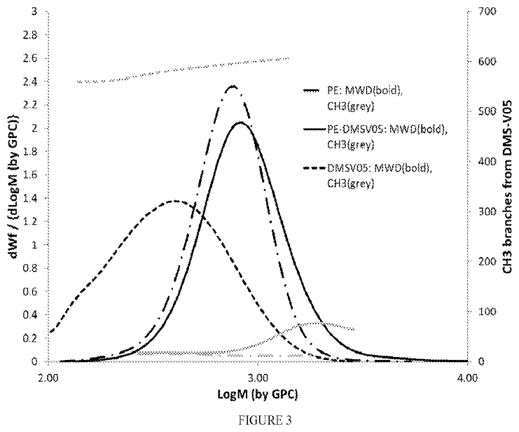

In the drybox (nitrogen atmosphere), ISOPAR-E solvent (10 ml), Co-Cat 1 (1.8 micromol) and TEA (0.22 mmol) were added to a 40 ml vial equipped with a stir bar. The vial was capped with a septum lined lid and placed in a heating block. The vial was connected to a C2 (ethylene) line, which was used to slowly purge the vial via a needle. After the temperature of the vial reached 100 °C (as indicated by the temperature of the heating block), the procatalyst 1 [(E)-((2,6-diisopropylphenyl)(2-methyl-3-(octylimino)butan-2-yl)amino)trimethyl hafnium], 1.5 micromol in 0.2 ml ISOPAR-E] was injected into the vial, and the purge needle was removed to maintain a total pressure at 12 psig (as determined by a pressure gauge on the ethylene line). The reaction was maintained for 20 minutes. After this time, the ethylene line was removed, and a portion of solution was taken and precipitated in MeOH to obtain pure polyethylene. Into the remaining solution in the vial, DMS-V05 (1 ML) was added, and the resulting solution was heated at 130 °C for 30 minutes, followed by precipitation of the reaction product in MeOH. Both the polyethylene and the reaction product were filtered and dried under vacuum. Each sample was analyzed by GPC. A compositional GPC overlay is shown in FIG. 3.

In FIG. 3, in regard to the “dW/dLogM” y-axis, at a Log M=3.00, the upper narrower profile is that for the polyethylene (PE), the next lower profile is that for the reaction product containing the PE-PDMS and PE, the lower broader profile is that for the DMS-V05.

The ²⁹Si NMR profile is shown in FIG. 4 and the ¹³C NMR profile is shown in FIG. 5. Based on ²⁹Si NMR, approximately 40% of the double bond of the “Si—C═C” moiety converted to Si—P (where P is the polyethylene polymer), based on the ratio of Si—CH₂—P/Si—CH═CH₂ (comparing Si peak intensities in Si NMR profile). Based on ¹³C NMR, approximately 47% of the double bond of the “Si—C═C” moiety converted to Si—P, based on the ratio of Si—CH₂—P/Si—CH—CH₂ (comparing carbon peak intensities in C NMR profile).

These NMR results each indicate that the reaction proceeded as noted in Scheme 6 above.

### Example 4

The synthesis of a polyethylene-PDMS comb-like block polymer is shown in Scheme 7.

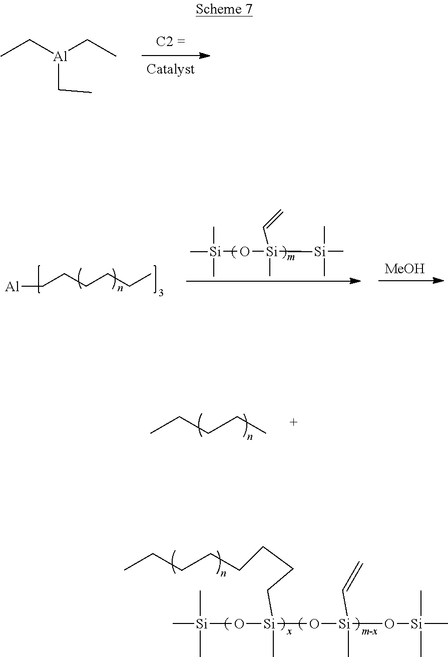

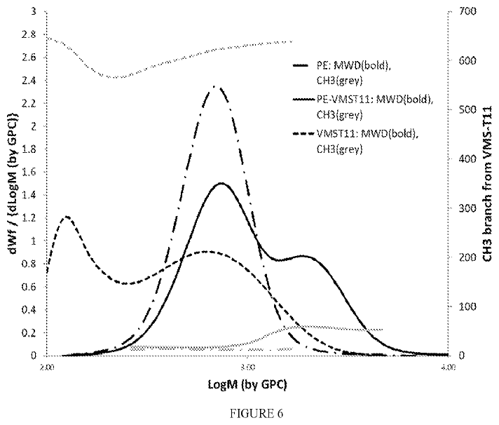

For Example 4, the same procedure, including the same amount of each component, was followed as in Example 3, except that VMS-T11 (1 ML) was used to replace DMS-V05. Each sample was analyzed by GPC. A compositional GPC overlay is shown in FIG. 6.

In FIG. 6, in regard to the “dW/dLogM” y-axis, at a Log M=3.00, the upper narrower profile is that for the polyethylene (PE), the next lower “bimodal-type” profile is that for the reaction product containing the PE-PDMS and PE, the lower broad profile is that for the VMS-T11.

As discussed above, in the above two polymerizations of Examples 3 and 4, for each reaction, the GPC curve of the block copolymer was overlaid with the starting siloxane and the polyethylene sample (taken before the addition of the siloxane). It is clear that the block copolymers have higher MW fractions as compared to the base polyethylene, especially for Example 4 where a bimodal MWD is shown, indicating that some block copolymers were formed.

### Study 3—GC Mass Spec of Reaction Products (Zn)

### Example 5

The reaction of Diethylzinc (DEZ) with 1,3-divinyltetramethyldisiloxane (DVTMDS)—see Scheme 8.

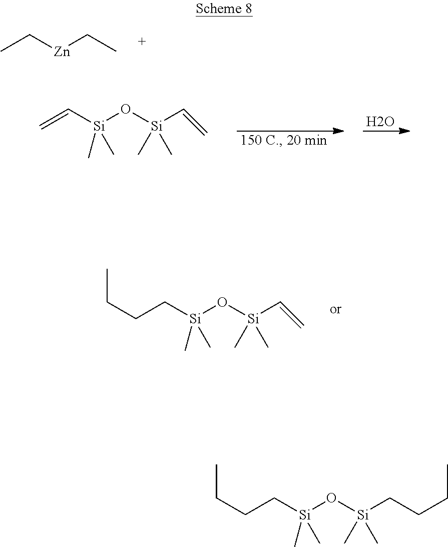

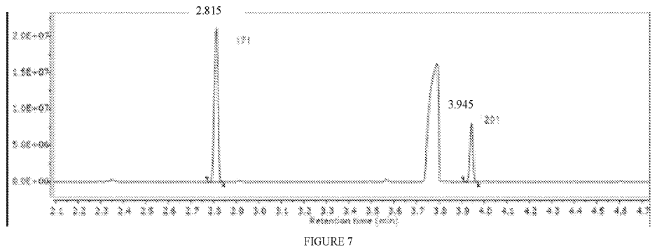

In a drybox, under nitrogen atmosphere, 1,3-divinyltetramethyldisiloxane (0.543 g, 2.9 mmol) and trioctylaluminum (0.3 ml, 2.9 mmol) were dissolved in 5 mL of decane, in a vial, and heated at 150 °C for 20 minutes. The resulting sample was hydrolyzed (with MeOH) for GC/MS analysis. The GC/MS result indicated the presence of an insertion product (m/z=201), as shown below, in accordance with Scheme 8. The corresponding GC/MS peak spectrum is shown in FIG. 7.

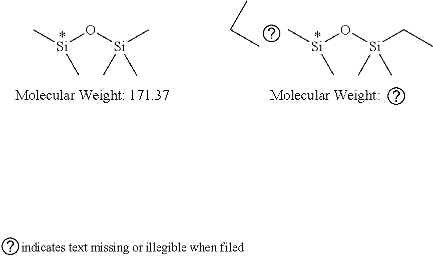

1. A process to form a composition comprising a siloxane modified olefin-based polymer, said process comprising reacting A) with B), each as shown below, to form C) as shown below: A) M[(CR1R2—CR3R4)n-CH3]x where M is a metal selected from Zn or Al; x is 2 or 3, and if x=2, then M is Zn, and if x=3, then M is Al; each n is independently ≥1; and for each respective 11 value, each of R¹, R², R³, R⁴ is independently H or a hydrocarbyl; and R¹ may or may not be the same for each successive repeat unit; R² may or may not be the same for each successive repeat unit; R³ may or may not be the same for each successive repeat unit; R⁴ may or may not be the same for each successive repeat unit;
B) a polysiloxane comprising at least one silyl vinyl group;
C) to form one or more polysiloxane-M-polymer complexes, each independently selected from i, ii, iii, iv, v, vi, vii, viii, ix or x: 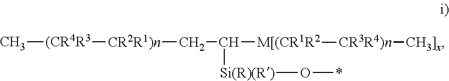
where each n is defined above, and each respective unit of R¹, R², R³, R⁴ is defined above; and each of R and R′ is independently a hydrocarbyl or a heterohydrocarbyl; x=1 or 2, and if x=1, then M is Zn, and if x=2, then M is Al; and the asterisk (*) represents the remainder of the complex; 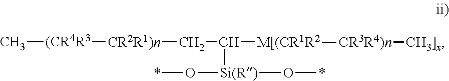
where each n is defined above, and each respective unit of R¹, R², R³, R⁴ is defined above; and R″ is a hydrocarbyl or a heterohydrocarbyl; x=1 or 2, and if x=1, then M is Zn, and if x=2, then M is Al; and each asterisk (*) independently represents the respective remainder of the complex; 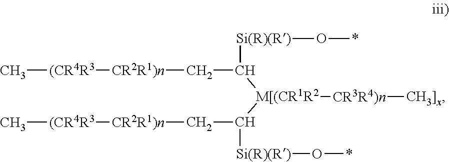
where each n is defined above, and each respective unit of R¹, R², R³, R⁴ is defined above; and each of R and R′ is independently a hydrocarbyl or a heterohydrocarbyl; x=0 or 1, and if x=0 (the [(CRlR2-CR3R4)n-CH3]) moiety is not present), then M is Zn, and if x=1, then M is Al; and each asterisk (*) independently represents the respective remainder of the complex; 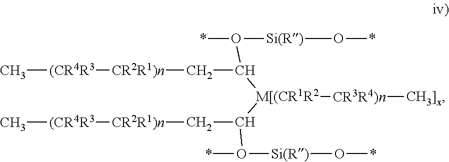
where each n is defined above, and each respective unit of R¹, R², R³, R⁴ is defined above; and each R″ is independently a hydrocarbyl or a heterohydrocarbyl; x=0 or 1, and if x=0 (the [(CR1R2-CR3R4)n-CH3]) moiety is not present), then M is Zn, and if x=1, then M is Al; and each asterisk (*) independently represents the respective remainder of the complex; 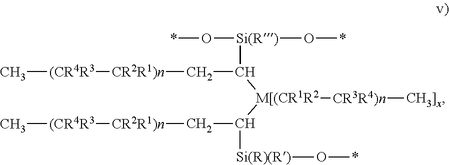
where each n is defined above, and each respective unit of R¹, R², R³, R⁴ is defined above; and each of R, R′ and R″ is independently a hydrocarbyl or a heterohydrocarbyl; x=0 or 1, and if x=0 (the [(CR1R2-CR3R4)n-CH3]) moiety is not present), then M is Zn, and if x=1, then M is Al; and each asterisk (*) independently represents the respective remainder of the complex; 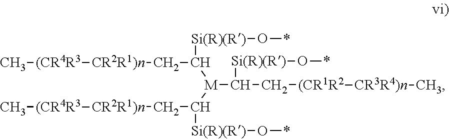
where each n is defined above, and each respective unit of R¹, R², R³, R⁴ is defined above; and each of R and R′ is independently a hydrocarbyl or a heterohydrocarbyl; and M is Al; and each asterisk (*) independently represents the respective remainder of the complex; 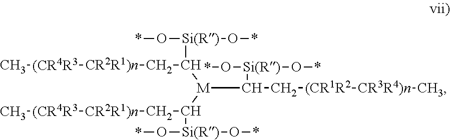
where each n is defined above, and each respective unit of R¹, R², R³, R⁴ is defined above; and each R″ is independently a hydrocarbyl or a heterohydrocarbyl; and M is Al; and each asterisk (*) independently represents the respective remainder of the complex; 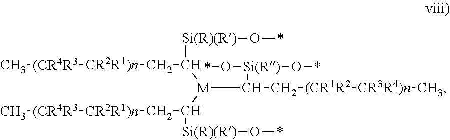
where each n is defined above, and each respective unit of R¹, R², R³, R⁴ is defined above; and each of R, R′ and R″ is independently a hydrocarbyl or a heterohydrocarbyl; and M is Al; and each asterisk (*) independently represents the respective remainder of the complex; 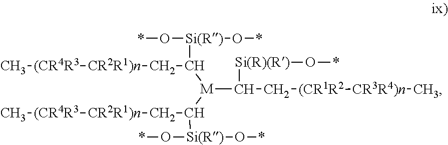
where each n is defined above, and each respective unit of R¹, R², R³, R⁴ is defined above; and each of R, R′ and R″ is independently a hydrocarbyl or a heterohydrocarbyl; and M is Al; and each asterisk (*) independently represents the respective remainder of the complex; or
x) any combination thereof;
hydrolyzing the one or more polysiloxane-M polymer complexes (C) to form the siloxane modified olefin-based polymer.

2. The process of claim 1, wherein, independently, for i, iii, v, vi, viii, ix, each of R and R′ is independently an alkyl group or a vinyl group.

3. The process of claim 1, wherein, independently, for i-ix, for each respective n value, each of R¹, R², R³, R⁴ is independently H or an alkyl group.

4. The process of claims 1, wherein, independently, for ii, iv, v, vii, viii, ix, each R″ is independently an alkyl group or a vinyl group.

5. The process of claims 1, wherein M is Al. 6. The process of claim 1, wherein the siloxane modified olefin-based polymer comprises the following polymeric segments a1 and/or a2, and b as follows:
a1) —O—Si(R)(R′)—CH2—CH2—(CR1R2—CR3R4)n-CH3, where n is defined herein; and each of R, R′ is defined herein; and each of R¹, R², R³, R⁴ is defined herein;
a2) —O—Si(R″)—CH2—CH2—((CR1R2—CR3R4)n-CH3)—, where n is defined herein; and R″ is defined herein; and each of R¹, R², R³, R⁴ is defined herein;
b) —(O—SiR′″(R″″))m-, where m≥1, and for each value of m, each of R″ and R″″ is independently an H or a hydrocarbyl.

7. The process of claim 6, wherein, for segment b, each of R′″ and R″″ is independently an H or an alkyl group.

8. The process of claims 1, wherein the process is a solution process.

9. The process of claims 1, wherein the process further comprises isolating “the composition comprising the siloxane modified olefin-based polymer.”10. The process of claims 1, wherein the composition further comprises an olefin-based polymer.

11. The process of claim 10, wherein the olefin-based polymer is an ethylene-based polymer.

12. A composition formed by the process of any one of claims 1.

13. The composition of claim 12, wherein the composition further comprises an olefin-based polymer.

14. The composition of claim 13, wherein the olefin-based polymer is an ethylene-based polymer.

15. The composition of claims 12, wherein the siloxane modified olefin-based polymer comprises at least one chain comprising at least one structure selected from T5) through T8), and where each asterisk (*) independently represents the respective remainder of the chain: 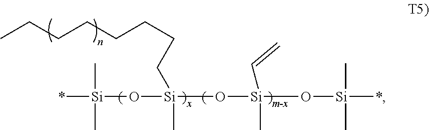
where m≥2; x≥1; n≥1; 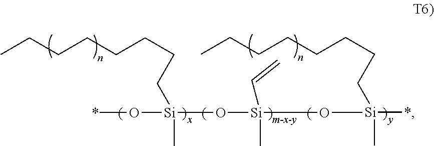
where m≥2; x≥1; y≥1; each n is independently≥1; 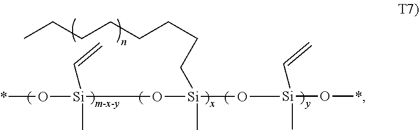
where m≥2; x≥1; y≥1; n≥1; or
T8) any combination thereof.

16. The composition of claim 12, wherein the composition comprises from 15 wt % to 95 wt % of the siloxane modified olefin-based polymer, based on the weight of the composition.

17. The composition of claim 13, wherein the composition comprises from 80.0 wt %, to 100.0 wt % of the sum of the siloxane modified polymer and the olefin-based polymer, based on the weight of the composition.

18. The composition of claim 12, wherein the siloxane modified olefin-based polymer is a siloxane modified ethylene-based polymer.

19. A crosslinked composition formed from the composition of claim 12.

20. An article comprising at least one component formed from the composition of claim 12.
